(19) United States
(12) Patent Application Publication
(10) Pub. No.: US 2003/0126033 A1
(43) Pub. Date: Jul. 3, 2003

(54) System, method and article of manufacture for software source authentication for return purposes

(76) Inventors: Damian P. Evans, Bellevue, WA (US); Pekka T. Huttunen, Seattle, WA (US); Ali Piyarali, Seattle, WA (US)

Correspondence Address: Attn: Douglas N. Larson, OPPENHEIMER WOLFF & DONNELLY LLP, Suite 3800, 2029 Century Park East, Los Angeles, CA, 90067, US

(21) Appl. No.: 10/234,529

(22) Filed: Sep. 3, 2002

Related U.S. Application Data
(63) Continuation of application No. 09/343,375, filed on Jun. 30, 1999, now abandoned.

(51) Int. Cl. G06F 17/60

(52) U.S. Cl. 705/26

(57) ABSTRACT

A system, method, and article of manufacture are provided for identifying electronically distributed software after distribution. First, software is electronically transferred to a user over a network in exchange for payment during a transaction. After the transaction, a proof-of-purchase is then downloaded over the network. Such proof-of-purchase identifies the transaction. Thereafter, a notice of return including the proof-of-purchase is received from the user over the network. The authenticity of the proof-of-purchase is verified, after which a value of a refund for the return is determined. The refund is then processed.

### FIELD OF INVENTION

The present invention relates to product dissemination, and particularly to processing a return of digital content products that were distributed electronically.

### BACKGROUND OF INVENTION

FIG. 1 (prior art) illustrates a traditional software distribution model. Software publishers 100 distribute a majority of their products to a tier 1 distributor 102. The distributor 102 then distributes the products to tier 2 Resellers 104, including retail/direct response resellers 106 and value added resellers (VARs) 108. The tier 2 resellers 110 then sell directly to consumers 110. The retail/direct response resellers 106 also sell the products, unchanged, directly to the consumers 110. The VARs 108 typically repackage the products for added value. Such repackaging may include bundling with other products or services. Examples of this include where software is bundled with a computer in a computer system purchase, or where user training or customer support is bundled with the software purchase. In some circumstances the software publishers may bypass the distributor 102 and sell direct to tier 2 resellers 104. In a few limited circumstances the software publishers may also bypass the distributor 102 and the tier 2 resellers 104 and sell direct to consumers 110.

Typically, software publisher 100 functions include: Designing and developing software products; designing and developing product updates, enhancements and bug fixes; building and maintaining channel and customer relationships; producing and distributing media and manuals; and creating product awareness and generating demand.

Software distributor 102 functions typically include: forecasting demand; ordering products from manufacturers; managing inventory; generating demand from resellers; fulfilling orders from resellers; managing reseller credit risk; providing customer service to resellers; and reporting sales and returns to software publishers.

Retail/direct response reseller 106 functions typically include: Forecasting demand: ordering products from distributors: managing inventory: generating demand from end users; selling products to end users; initiating and completing financial transactions; managing end user credit risk; providing value-added services to end users, such as configuration and installation; providing post-sales customer service; and reporting sales and returns to distributors.

Value added reseller (VAR) 108 functions typically include: Generating demand from end users; receiving and validating orders; ordering products from distributors; initiating and completing financial transactions; managing end user credit risk; providing value-added services to end users, such as customization, integration and training; and providing post-sales customer service.

In this traditional distribution model, shown in FIG. 1, a consumer 110 goes to a tier 2 reseller's 104 retail outlet, selects a product for purchase, and interacts with a sales clerk to purchase the product. The consumer purchases the product by a variety of methods, e.g., cash, check, credit card or debit card. The consumer must, however, physically visit the retail outlet during its business hours.

Also in this traditional distribution model, each level of the model must profit from the distribution of the products, and FIG. 2 (prior art) illustrates a typical price increase as a product moves from publisher to distributor. The software publisher 100 sells the products to the distributor 102 at a wholesale price of $81.84. This amount represents the cost of development, manufacturing, packaging and publisher's 100 profit. The distributor 102 then increases the price to a distribution price of $86.60 and sells the product to a tier 2 reseller 104. The tier 2 reseller 104, in turn, further increase the price to a retail price of $100.00 and sells the product to the consumer 110. This multitiered method causes the price to be higher than is necessary if distribution were more direct, from the software publishers 100 to consumers 110.

FIG. 3 (prior art) illustrates an alternative software distribution scheme. In this scheme, the consumer 300 establishes a connection between the consumer's computer 302 and a host computer 304 via a telephone connection 306. The consumer 300 then selects and downloads the product. The consumer 300 uses the product and, if willing, sends payment by U.S. Postal Service, or similar courier, and arranges a payment by credit card or debit card to the product source 308, e.g. the software publisher, tier 2 reseller, etc.

In the foregoing scheme, the consumer must be a sufficiently sophisticated computer user to establish the telephone connection, download and finally install the software. To further complicate matters, a separate step of paying for the software is required. Many software publishers or tier 2 resellers are unwilling to download or otherwise distribute products without first receiving a payment or a payment guarantee, and most consumers do not sufficiently trust the software publishers or tier 2 resellers to pay before using or at least seeing the products first.

The Internet and the World Wide Web has introduced yet another method of distribution of software. In this method, a consumer views a commercial website distributor offering software for sale. The consumer places the order by selecting the specific software for purchase, submitting his personal financial information (e.g. credit or debit account information), and then the software is shipped to the consumer via conventional freight transport systems (e.g. U.S. Postal Service, United Parcel Service, Federal Express, etc.).

More recent developments in the Internet and World Wide Web have allowed higher speed connections to consumers' personal computers. Such higher speed connections allow direct downloads of the software from a software publisher's or distributor's website to the consumer's personal computer. This process is referred to as electronic software distribution (ESD).

ESD provides benefits to all participants in the software distribution chain. Software publishers can eliminate investments in manufacturing capacity, and the cost of producing and distributing physical software packages, along with the risk of holding obsolete inventory. Distributors and Resellers can eliminate the costs of forecasting demand; ordering, holding, and fulfilling orders for physical packages of software; and can eliminate the risk of holding obsolete inventory. Consumers can acquire software immediately, without the current waiting time for delivery, and can begin to take advantage of new services such as software subscriptions, trial-before-purchase, and automatic upgrades.

There are, however, substantial issues with these processes for the consumers, the software distributors and the software publisher/copyright owners.

Consumers are hesitant to provide sensitive, personal financial data (e.g. credit and debit account) over the Internet to a software distributor. Consumers' concerns are based upon many factors: Misuse or misappropriation of the consumers' financial data; inability to physically visit the software distributor, which may be physically located in a distant city or even a different country; and limited customer service and product support offerings.

Software distributors are primarily concerned about receiving a valid payment. If a consumer provides the software distributor with fraudulent personal financial data (e.g. credit and debit account) then the software distributor likely will not receive payment for the product.

Software publishers and copyright owners are concerned about the misuse, misappropriation and outright piracy of the copyrighted software.

There is therefore a need for a new scheme for the distribution and sale of digital content products which more adequately addresses the needs of the consumers, the software distributors and software publisher/copyright owners.

### SUMMARY OF INVENTION

The present invention processes returns and refinds for software distributed over a network. In more detail, a system, method, and article of manufacture are provided for identifying electronically distributed software after distribution. First, software is electronically transferred to a user over a network in exchange for payment during a transaction. After the transaction, a proof-of-purchase is downloaded over the network. Such proof-of-purchase identifies the transaction. Thereafter, a notice of return including the proof-of-purchase is received from the user over the network. The authenticity of the proof-of-purchase is verified, after which a value of a refund for the return is determined. The value of the refund may be based on whether the user has used the software and how long the user has had the software, among other things. The refund is then processed and some or all of the purchase price is returned to the user.

In one embodiment of the present invention, the proof-of-purchase may include an identifier of a source of the software for verification. The proof-of-purchase would help to ensure that a user has not merely made a copy of the software and is trying to return the bogus copy for a refund. Further, information relating to the proof-of-purchase and the refund may be stored in a record. The identification of the user as shown on the proof of purchase could be compared to the record to ensure that the proof-of-purchase is not bogus or that the user is trying to obtain multiple refunds for the same purchase. As another option, the record may be transferred to a source of the software.

In yet another embodiment of the present invention, the network may include a LAN, a WAN, and an IP-based network. As an alternative, the network may include a dedicated one-to-one telephonic hard-line. Additionally, the network may include a cellular, digital wireless, or satellite-based network.

These and other advantages of the present invention will become apparent to those skilled in the art upon a reading of the following descriptions of the invention and a study of the several figures of the drawings.

### BRIEF DESCRIPTION OF DRAWINGS

The invention will be better understood when consideration is given to the following detailed description thereof Such description makes reference to the annexed drawings wherein:

FIG. 1 is an illustration of a software distribution scheme of the prior art;

FIG. 2 is an illustration of the exchange of money in the prior art software distribution scheme of FIG. 1;

FIG. 3 is an illustration of yet another software distribution scheme of the prior art;

FIG. 4 is a schematic diagram of a hardware implementation of one embodiment of the present invention;

FIG. 5 is a schematic diagram of an electronic software distribution scheme according to one embodiment of the present invention;

FIG. 5A is a schematic diagram of an electronic software distribution scheme according to one embodiment of the present invention;

FIG. 6 is a flowchart illustrating the various operations associated with the embodiment of FIG. 5;

FIG. 7 is a flowchart illustrating a tracking process associated with the embodiment of FIG. 5;

FIG. 8 is a flowchart illustrating a process associated with the embodiment of FIG. 5, wherein payment is received after the downloading of software;

FIG. 9 is a flowchart illustrating a process corresponding with the embodiment of FIG. 5 which generates a license agreement associated with a sale of software;

FIG. 10 is a flowchart illustrating a process for software source authentication associated with the embodiment of FIG. 5;

FIG. 11 is a flowchart illustrating a customer support process associated with the embodiment of FIG. 5;

FIG. 12 is a schematic diagram illustrating a framework of a support interface associated with the process shown in FIG. 11;

FIG. 13 is an illustration of a graphical user interface associated with the framework shown in FIG. 12;

FIG. 14 is a flowchart illustrating a plurality of operations associated with the implementation of the support interface of FIGS. 12 and 13;

FIG. 15 is another flowchart illustrating a plurality of operations associated with the implementation of the support interface of FIGS. 12 and 13;

FIG. 16 is a schematic diagram illustrating a combination of the features of the present invention that may be used to establish one type of electronic software distribution framework;

FIG. 17 is a schematic diagram illustrating a combination of the features of the present invention that may be used in addition to the framework of FIG. 16;

FIG. 18 is a schematic diagram illustrating a combination of the features of the present invention that may be used in addition to the framework of FIG. 17;

FIG. 19 is a flowchart illustrating a process of establishing a user profile database for use with the various features of the present invention;

FIG. 20 is a flowchart illustrating an optional method of selling products, i.e. software, which employs a user profile database similar to that generated by the process of FIG. 19;

FIG. 21 illustrates manufacture of a packaged digital product according to one form of the present invention;

FIG. 22 illustrates by flow chart execution of the packaged digital product illustrated in FIG. 21 on a user-consumer's personal computer;

FIG. 23 illustrates by flow chart point of sale programming executing on a user-consumer's personal computer allowing the user-consumer to purchase and obtain a usable form of a digital product selected for purchase; and

FIG. 24 illustrates by flow chart credit card processor server programming interactive with the point of sale programming illustrated in FIG. 23.

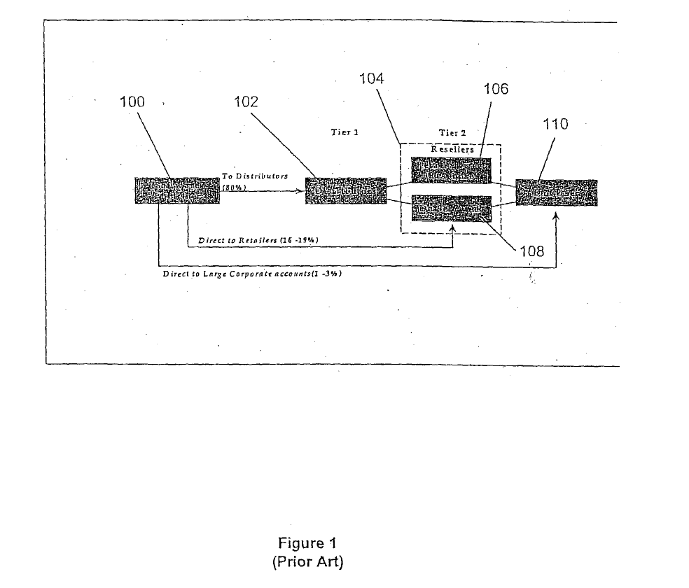

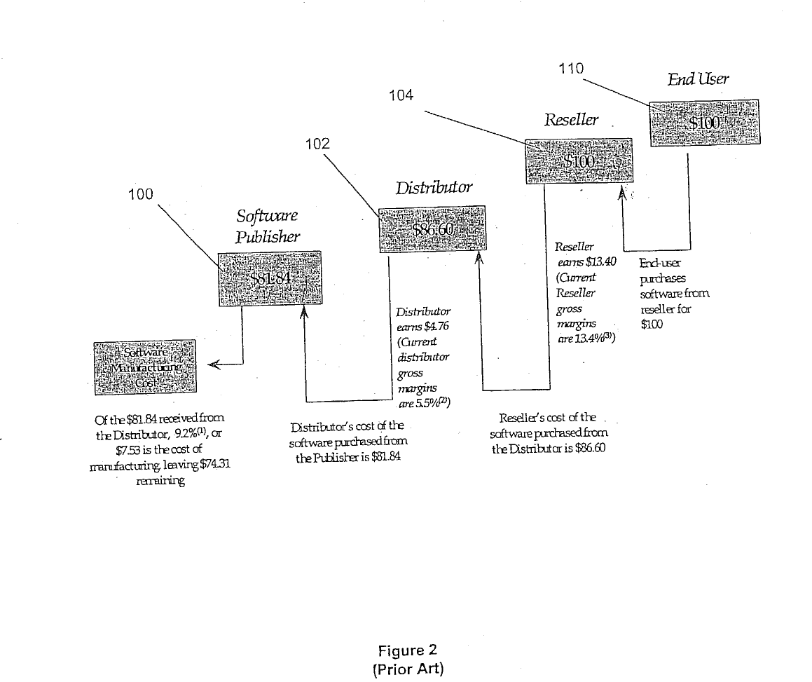

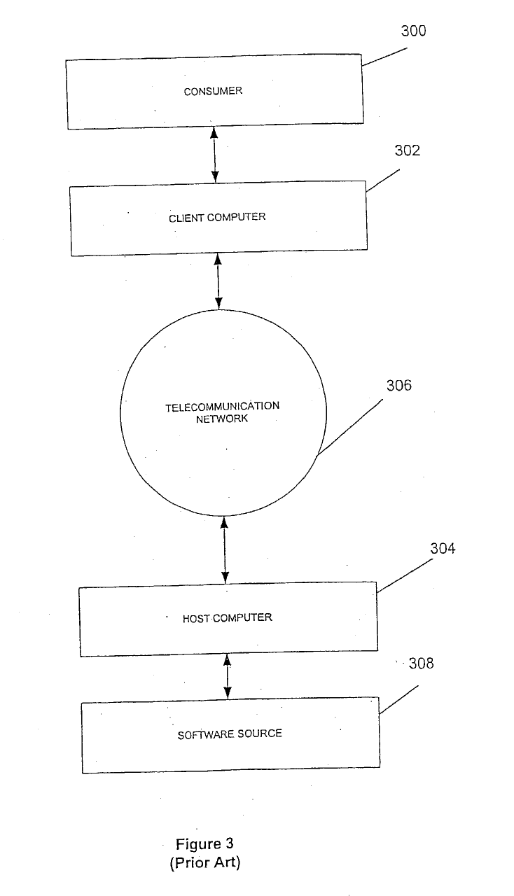

### DISCLOSURE OF INVENTION

The present invention is provided for the distribution and sale of digital content products. In order to accomplish this, one embodiment of the present invention is practiced on a network such as the Internet which interconnects a vast number of client computers. It should be noted that in various embodiments, the network may include a local area network (LAN), a wide area network (WAN), or any IP-based network. In the alternative, the network may include a dedicated one-to-one telephonic hard-line. The client computers may include a personal computer such as an IBM compatible personal computer, Apple Macintosh computer or UNIX based workstation.

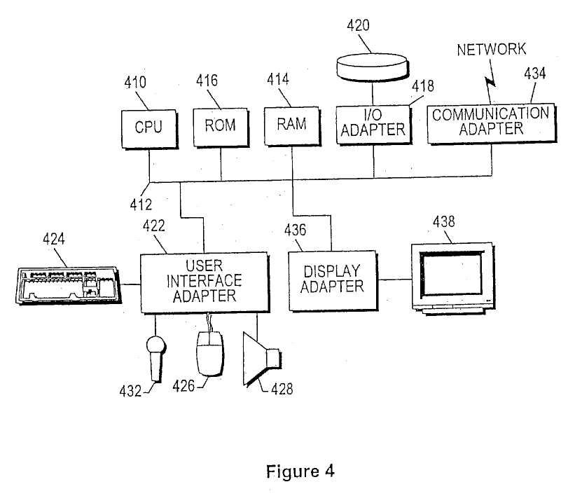

A representative hardware environment of the foregoing personal computers is depicted in FIG. 4, which illustrates a typical hardware configuration of a workstation in accordance with a preferred embodiment having a central processing unit 410, such as a microprocessor, and a number of other units interconnected via a system bus 412. The workstation shown in FIG. 4 includes a Random Access Memory (RAM) 414, Read Only Memory (ROM) 416, an I/O adapter 418 for connecting peripheral devices such as disk storage units 420 to the bus 412, a user interface adapter 422 for connecting a keyboard 424, a mouse 426, a speaker 428, a microphone 432, and/or other user interface devices such as a touch screen (not shown) to the bus 412, communication adapter 434 for connecting the workstation to a communication network (e.g., a data processing network) and a display adapter 436 for connecting the bus 412 to a display device 438.

The workstation typically has resident thereon an operating system such as the Microsoft Windows NT or Windows/95 Operating System (OS), the IBM OS/2 operating system, the MAC OS, or UNIX operating system. Those skilled in the art will appreciate that the present invention may also be implemented on platforms and operating systems other than those mentioned.

Operating on the hardware is software. One embodiment of software is written using JAVA, C, and the C++ language and utilizes object oriented programming methodology. Object oriented programming (OOP) has become increasingly used to develop complex applications. As OOP moves toward the mainstream of software design and development, various software solutions require adaptation to make use of the benefits of OOP. A need exists for these principles of OOP to be applied to a messaging interface of an electronic messaging system such that a set of OOP classes and objects for the messaging interface can be provided.

OOP is a process of developing computer software using objects, including the steps of analyzing the problem, designing the system, and constructing the program. An object is a software package that contains both data and a collection of related structures and procedures. Since it contains both data and a collection of structures and procedures, it can be visualized as a self-sufficient component that does not require other additional structures, procedures or data to perform its specific task. OOP, therefore, views a computer program as a collection of largely autonomous components, called objects, each of which is responsible for a specific task. This concept of packaging data, structures, and procedures together in one component or module is called encapsulation.

In general, OOP components are reusable software modules which present an interface that conforms to an object model and which are accessed at run-time through a component integration architecture. A component integration architecture is a set of architecture mechanisms which allow software modules in different process spaces to utilize each others capabilities or functions. This is generally done by assuming a common component object model on which to build the architecture. It is worthwhile to differentiate between an object and a class of objects at this point. An object is a single instance of the class of objects, which is often just called a class. A class of objects can be viewed as a blueprint, from which many objects can be formed.

OOP allows the programmer to create an object that is a part of another object. For example, the object representing a piston engine is said to have a composition-relationship with the object representing a piston. In reality, a piston engine comprises a piston, valves and many other components; the fact that a piston is an element of a piston engine can be logically and semantically represented in OOP by two objects.

OOP also allows creation of an object that “depends from” another object. If there are two objects, one representing a piston engine and the other representing a piston engine wherein the piston is made of ceramic, then the relationship between the two objects is not that of composition. A ceramic piston engine does not make up a piston engine. Rather it is merely one kind of piston engine that has one more limitation than the piston engine; its piston is made of ceramic. In this case, the object representing the ceramic piston engine is called a derived object, and it inherits all of the aspects of the object representing the piston engine and adds further limitation or detail to it. The object representing the ceramic piston engine “depends from” the object representing the piston engine. The relationship between these objects is called inheritance.

When the object or class representing the ceramic piston engine inherits all of the aspects of the objects representing the piston engine, it inherits the thermal characteristics of a standard piston defined in the piston engine class. However, the ceramic piston engine object overrides these ceramic specific thermal characteristics, which are typically different from those associated with a metal piston. It skips over the original and uses new functions related to ceramic pistons. Different kinds of piston engines have different characteristics, but may have the same underlying functions associated with it (e.g., how many pistons in the engine, ignition sequences, lubrication, etc.). To access each of these functions in any piston engine object, a programmer would call the same functions with the same names, but each type of piston engine may have different/overriding implementations of functions behind the same name. This ability to hide different implementations of a function behind the same name is called polymorphism and it greatly simplifies communication among objects.

With the concepts of composition-relationship, encapsulation, inheritance and polymorphism, an object can represent just about anything in the real world. In fact, our logical perception of the reality is the only limit on determining the kinds of things that can become objects in object-oriented software. Some typical categories are as follows:

Objects can represent physical objects, such as automobiles in a traffic-flow simulation, electrical components in a circuit-design program, countries in an economics model, or aircraft in an air-traffic-control system.

Objects can represent elements of the computer-user environment such as windows, menus or graphics objects.

An object can represent an inventory, such as a personnel file or a table of the latitudes and longitudes of cities.

An object can represent user-defined data types such as time, angles, and complex numbers, or points on the plane.

With this enormous capability of an object to represent just about any logically separable matters, OOP allows the software developer to design and implement a computer program that is a model of some aspects of reality, whether that reality is a physical entity, a process, a system, or a composition of matter. Since the object can represent anything, the software developer can create an object which can be used as a component in a larger software project in the future.

If 90% of a new OOP software program consists of proven, existing components made from preexisting reusable objects, then only the remaining 10% of the new software project has to be written and tested from scratch. Since 90% already came from an inventory of extensively tested reusable objects, the potential domain from which an error could originate is 10% of the program. As a result, OOP enables software developers to build objects out of other, previously built objects.

This process closely resembles complex machinery being built out of assemblies and sub-assemblies. OOP technology, therefore, makes software engineering more like hardware engineering in that software is built from existing components, which are available to the developer as objects. All this adds up to an improved quality of the software as well as an increased speed of its development.

Programming languages are beginning to fully support the OOP principles, such as encapsulation, inheritance, polymorphism, and composition-relationship. With the advent of the C++ language, many commercial software developers have embraced OOP. C++ is an OOP language that offers a fast, machine-executable code. Furthermore, C++ is suitable for both commercial-application and systems-programming projects. For now, C++ appears to be the most popular choice among many OOP programmers, but there is a host of other OOP languages, such as Smalltalk, Common Lisp Object System (CLOS), and Eiffel. Additionally, OOP capabilities are being added to more traditional popular computer programming languages such as Pascal.

The benefits of object classes can be summarized, as follows:

Objects and their corresponding classes break down complex programming problems into many smaller, simpler problems.

Encapsulation enforces data abstraction through the organization of data into small, independent objects that can communicate with each other. Encapsulation protects the data in an object from accidental damage, but allows other objects to interact with that data by calling the object's member functions and structures.

Sub-classing and inheritance make it possible to extend and modify objects through deriving new kinds of objects from the standard classes available in the system. Thus, new capabilities are created without having to start from scratch.

Polymorphism and multiple inheritance make it possible for different programmers to mix and match characteristics of many different classes and create specialized objects that can still work with related objects in predictable ways.

Class hierarchies and containment hierarchies provide a flexible mechanism for modeling real-world objects and the relationships among them.

Libraries of reusable classes are useful in many situations, but they also have some limitations. For example:

Complexity. In a complex system, the class hierarchies for related classes can become extremely confusing, with many dozens or even hundreds of classes.

Flow of control. A program written with the aid of class libraries is still responsible for the flow of control (i.e., it must control the interactions among all the objects created from a particular library). The programmer has to decide which functions to call at what times for which kinds of objects.

Duplication of effort. Although class libraries allow programmers to use and reuse many small pieces of code, each programmer puts those pieces together in a different way. Two different programmers can use the same set of class libraries to write two programs that do exactly the same thing but whose internal structure (i.e., design) may be quite different, depending on hundreds of small decisions each programmer makes along the way. Inevitably, similar pieces of code end up doing similar things in slightly different ways and do not work as well together as they should.

Class libraries are very flexible. As programs grow more complex, more programmers are forced to reinvent basic solutions to basic problems over and over again. A relatively new extension of the class library concept is to have a framework of class libraries. This framework is more complex and consists of significant collections of collaborating classes that capture both the small scale patterns and major mechanisms that implement the common requirements and design in a specific application domain. They were first developed to free application programmers from the chores involved in displaying menus, windows, dialog boxes, and other standard user interface elements for personal computers.

Frameworks also represent a change in the way programmers think about the interaction between the code they write and code written by others. In the early days of procedural programming, the programmer called libraries provided by the operating system to perform certain tasks, but basically the program executed down the page from start to finish, and the programmer was solely responsible for the flow of control. This was appropriate for printing out paychecks, calculating a mathematical table, or solving other problems with a program that executed in just one way.

The development of graphical user interfaces began to turn this procedural programming arrangement inside out. These interfaces allow the user, rather than program logic, to drive the program and decide when certain actions should be performed. Today, most personal computer software accomplishes this by means of an event loop which monitors the mouse, keyboard, and other sources of external events and calls the appropriate parts of the programmer's code according to actions that the user performs. The programmer no longer determines the order in which events occur. Instead, a program is divided into separate pieces that are called at unpredictable times and in an unpredictable order. By relinquishing control in this way to users, the developer creates a program that is much easier to use. Nevertheless, individual pieces of the program written by the developer still call libraries provided by the operating system to accomplish certain tasks, and the programmer must still determine the flow of control within each piece after it's called by the event loop. Application code still “sits on top of” the system.

Even event loop programs require programmers to write a lot of code that should not need to be written separately for every application. The concept of an application framework carries the event loop concept further. Instead of dealing with all the nuts and bolts of constructing basic menus, windows, and dialog boxes and then making these things all work together, programmers using application frameworks start with working application code and basic user interface elements in place. Subsequently, they build from there by replacing some of the generic capabilities of the framework with the specific capabilities of the intended application.

Application frameworks reduce the total amount of code that a programmer has to write from scratch. However, because the framework is really a generic application that displays windows, supports copy and paste, and so on, the programmer can also relinquish control to a greater degree than event loop programs permit. The framework code takes care of almost all event handling and flow of control, and the programmer's code is called only when the framework needs it (e.g., to create or manipulate a proprietary data structure).

A programmer writing a framework program not only relinquishes control to the user (as is also true for event loop programs), but also relinquishes the detailed flow of control within the program to the framework. This approach allows the creation of more complex systems that work together in interesting ways, as opposed to isolated programs, having custom code, being created over and over again for similar problems.

Thus, as is explained above, a framework basically is a collection of cooperating classes that make up a reusable design solution for a given problem domain. It typically includes objects that provide default behavior (e.g., for menus and windows), and programmers use it by inheriting some of that default behavior and overriding other behavior so that the framework calls application code at the appropriate times.

There are three main differences between frameworks and class libraries:

Behavior versus protocol. Class libraries are essentially collections of behaviors that you can call when you want those individual behaviors in your program. A framework, on the other hand, provides not only behavior but also the protocol or set of rules that govern the ways in which behaviors can be combined, including rules for what a programmer is supposed to provide versus what the framework provides.

Call versus override. With a class library, the code the programmer instantiates objects and calls their member functions. It's possible to instantiate and call objects in the same way with a framework (i.e., to treat the framework as a class library), but to take full advantage of a framework's reusable design, a programmer typically writes code that overrides and is called by the framework. The framework manages the flow of control among its objects. Writing a program involves dividing responsibilities among the various pieces of software that are called by the framework rather than specifying how the different pieces should work together.

Implementation versus design. With class libraries, programmers reuse only implementations, whereas with frameworks, they reuse design. A framework embodies the way a family of related programs or pieces of software work. It represents a generic design solution that can be adapted to a variety of specific problems in a given domain. For example, a single framework can embody the way a user interface works, even though two different user interfaces created with the same framework might solve quite different interface problems.

Thus, through the development of frameworks for solutions to various problems and programming tasks, significant reductions in the design and development effort for software can be achieved. A preferred embodiment of the invention utilizes Hyper Text Markup Language (HTML) to implement documents on the Internet together with a general-purpose secure communication protocol for a transport medium between the client and the Newco. HTTP or other protocols could be readily substituted for HTML without undue experimentation. Information on these products is available in T. Berners-Lee, D. Connoly, “RFC 1866: Hypertext Markup Language—2.0” (November 1995); and R. Fielding, H, Frystyk, T. Berners-Lee, J. Gettys and J. C. Mogul, “Hypertext Transfer Protocol—HTTP/1.1: HTTP Working Group Internet Draft” (May 2, 1996). HTML is a simple data format used to create hypertext documents that are portable from one platform to another. HTML documents are SGML documents with generic semantics that are appropriate for representing information from a wide range of domains. HTML has been in use by the World-Wide Web global information initiative since 1990. HTML is an application of ISO Standard 8879; 1986 Information Processing Text and Office Systems; Standard Generalized Markup Language (SGML).

To date, Web development tools have been limited in their ability to create dynamic Web applications which span from client to server and interoperate with existing computing resources. Until recently, HTML has been the dominant technology used in development of Web-based solutions. However, HTML has proven to be inadequate in the following areas:

Poor performance;

Restricted user interface capabilities;

Can only produce static Web pages;

Lack of interoperability with existing applications and data; and

Inability to scale.

Sun Microsystems's Java language solves many of the client-side problems by:

Improving performance on the client side;

Enabling the creation of dynamic, real-time Web applications; and

Providing the ability to create a wide variety of user interface components.

With Java, developers can create robust User Interface (UI) components. Custom “widgets” (e.g., real-time stock tickers, animated icons, etc.) can be created, and client-side performance is improved. Unlike HTML, Java supports the notion of client-side validation, offloading appropriate processing onto the client for improved performance. Dynamic, real-time Web pages can be created. Using the above-mentioned custom UI components, dynamic Web pages can also be created.

Sun's Java language has emerged as an industry-recognized language for “programming the Internet.” Sun defines Java as: “a simple, object-oriented, distributed, interpreted, robust, secure, architecture-neutral, portable, high-performance, multithreaded, dynamic, buzzword-compliant, general-purpose programming language. Java supports programming for the Internet in the form of platform-independent Java applets.” Java applets are small, specialized applications that comply with Sun's Java Application Programming Interface (API) allowing developers to add “interactive content” to Web documents (e.g., simple animations, page adornments, basic games, etc.). Applets execute within a Java-compatible browser (e.g., Netscape Navigator) by copying code from the server to client. From a language standpoint, Java's core feature set is based on C++. Sun's Java literature states that Java is basically, “C++ with extensions from Objective C for more dynamic method resolution.”

Another technology that provides similar function to JAVA is provided by Microsoft and ActiveX Technologies, to give developers and Web designers wherewithal to build dynamic content for the Internet and personal computers. ActiveX includes tools for developing animation, 3-D virtual reality, video and other multimedia content. The tools use Internet standards, work on multiple platforms, and are being supported by over 100 companies. The group's building blocks are called ActiveX Controls, small, fast components that enable developers to embed parts of software in hypertext markup language (HTML) pages. ActiveX Controls work with a variety of programming languages including Microsoft Visual C++, Borland Delphi, Microsoft Visual Basic programming system and, in the future, Microsoft's development tool for Java, code named “Jakarta.” ActiveX Technologies also includes ActiveX Server Framework, allowing developers to create server applications. One of ordinary skill in the art readily recognizes that ActiveX could be substituted for JAVA without undue experimentation to practice the invention.

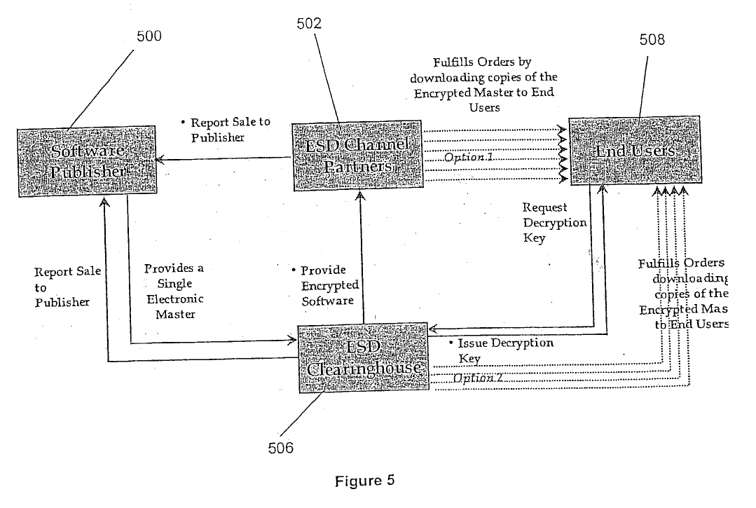

FIG. 5 illustrates an electronic software distribution (ESD) system in accordance with one embodiment of the present invention. The software publisher 500 produces the software for electronic distribution. The ESD channel partners 502 include the distribution network of distributors retailers and value added resellers (VARs). The End User—Consumer 508 uses the software and provides payment for the software.

Software publishers publish much more than computer software products. Software publishers also publish digital information such as databases and image data. As used herein, software includes all digital information, content, image data and other digitally distributable data.

The ESD system eliminates several functions of the software publisher 500 including:

Software manufacturing

Demand forecasting

Inventory management

Order fulfillment

These eliminated functions provide significant cost savings to the software publisher 500 through a reduction in the cost of goods sold and a reduction in the cost of inventory risk. Reductions of the cost of goods sold are a result of reducing or eliminating the physical reproduction of the software e.g. disks, reproduction equipment and labor, boxes, manuals and shipping. When distributing software electronically, there may no longer need to be a one-to-one relationship between the number of units shipped by the publisher and the number of units sold or returned, or in channel consignment inventory. The inventory risk of stocking obsolete inventory and inventory carrying charges can be significantly reduced or eliminated through the ESD system since physical inventory may no longer need to be stored on shelves awaiting an order. Further, the lack of physical inventory requirements may further reduce overhead facility costs since warehouse space and labor may no longer be required.

The ESD system eliminates several functions of the ESD channel partners 502 including:

Demand forecasting

Inventory management

These eliminated functions provide significant cost savings to the ESD channel partners 502 through a reduction in the inventory management, labor, warehouse and other increases in operations efficiencies and reduced information systems and inventory management requirements.

The ESD system requires the software publisher 500 to continue to provide the following existing functions:

Software development

Distribution to channel partners

Demand generation through advertisement and promotion

Channel management

Reseller credit risk management

Sales reporting

The ESD system does not require the software publisher 500 to provide any additional functions than previous distribution methods but does eliminate several previous functions.

The ESD system requires the ESD channel partners 502 to continue to provide the following existing functions:

Demand generation through advertisement and promotion

Order fulfillment

End user credit risk management

Sales reporting

Value added services

Product selection

Customization

Installation/integration

Training

The system of FIG. 5 thus allows a redefining of the roles of the software publisher 500 and ESD channel partners 502. This is accomplished by the introduction of another entity, namely an independent, third party “clearinghouse” 506 provides a value added service to the publisher 500.

The clearinghouse 506 provides the vital element of trust in the ESD. The independent certifying agency provides a “level of compliance” opinion of the clearinghouse. The certifying agency utilizes a series of standard tests, requirements and guidelines to check a channel partner's set of systems. Optionally, receiving ESD system certification may be required to be a channel partner or a clearinghouse for a software publisher's ESD.

FIG. 5A is a general block diagram which illustrates the various facets and an example of scope the clearinghouse may encompass. As shown, the various components of the clearinghouse may include: storefront front end 510, content creation and management 512, content support 514, user interface 516, user interface support 518, e-channel management 519, e-channel support 520, royalty management 522, royalties and usage settlement 524, commerce support 526, fulfillment back end 528, marketing intelligence management 530, and marketing intelligence 532.

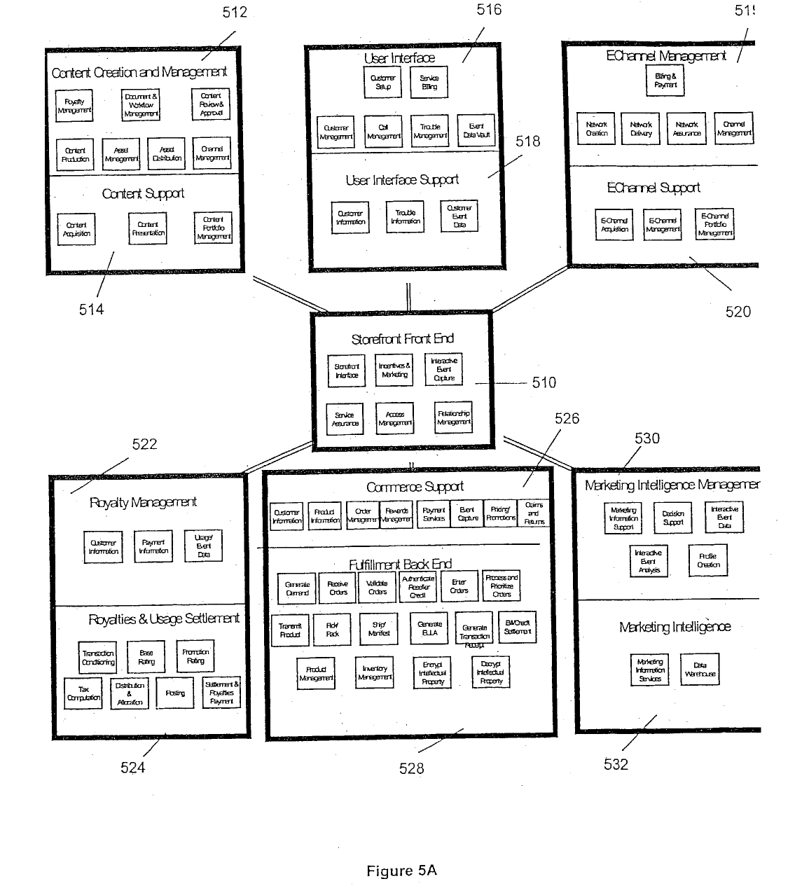

FIG. 6 illustrates, in most general terms, the various services afforded by the clearinghouse during the electronic distribution software over the network. For example, after a piece of software is provided by a publisher in operation 600, a user interface is provided for facilitating sale of the software in operation 602. The software for sale is advertised on the user interface. See operation 603. The software may also be downloaded and further sold by receiving payment in exchange for the software via the user interface in operations 604 and 606, respectively. As an option, the downloaded software may be encrypted and further decrypted upon the receipt of the payment.

In operation 608, support for the software via the user interface is also provided. In order to facilitate the support function, a proof-of-purchase may be sent to the user upon the receipt of the payment. An electronic proof of purchase may be sent such as via e-mail, or a proof of purchase on paper may be prepared for sending to the user via ground mail, for example. Additionally, the proof of purchase may be sent to the user via facsimile. Further, an end user license agreement may be transmitted to the user upon the receipt of the payment.

Royalties are allocated based on the sale of the software in operation 610. It should be noted that such royalty allocation may be based on a predetermined contract or agreement between the clearinghouse 506, publisher 500, and ESD channel partners 502. Payment may be administered automatically or manually by a separate party or one of the above parties 506, 500, and/or 502.

As mentioned earlier, the clearinghouse 506 may be adapted to downloaded software in an encrypted form and further decrypt such encrypted software upon the receipt of the payment. By this capability, the present invention is capable of tracking the distribution and sale of digital content products for reporting revenues to a publisher.

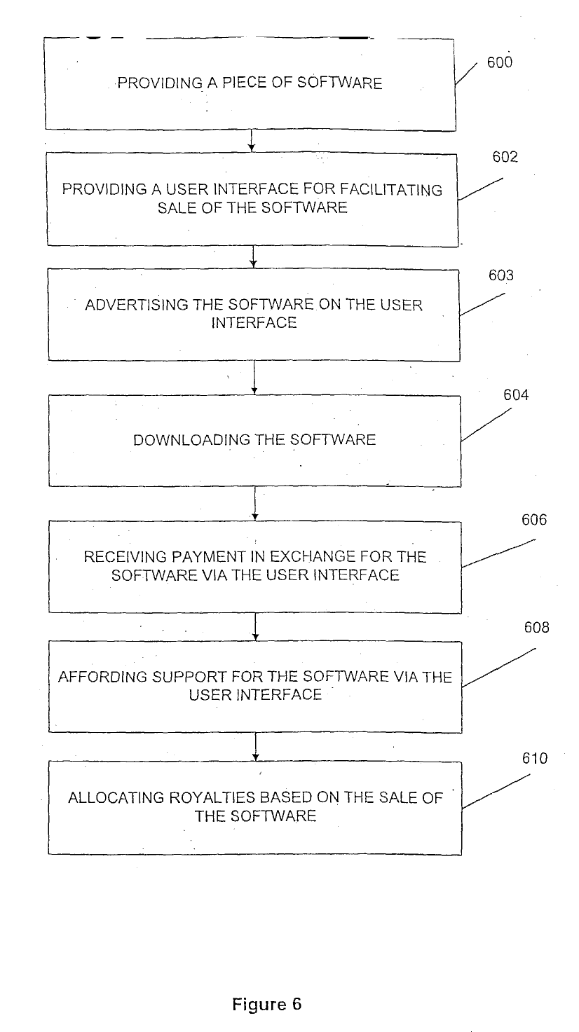

FIG. 7 is a flowchart illustrating the various operations involved with such tracking feature. First, in operation 700, encrypted software and a plurality of decryption keys are provided which each allow use of corresponding encrypted software. As an option, each decryption key is adapted to allow use of only a single piece of corresponding software, or a single sale. This renders duplication of the decryption key useless, thereby lessening the chance of unauthorized use of the software. Next, a request is received for a decryption key from a requestor. Thereafter, a transaction represented by the request for the decryption key is logged. Note operations 702 and 704.

The decryption key is then outputted to the requester in operation 706. Thereafter, the transaction is reported to a source of the software for allowing the tracking of revenue generated by the sale of the software, as indicated in operation 708. In the case where multiple ESD channel partners 502 are supported by a single clearinghouse 506, a plurality of requests may be received from such multiple requesters and the requests may be logged separately for each requestor.

As such, in its most limited form, the present invention provides the publisher 500 with an independent, objective reporting of sales by the channel partners 502, by receiving requests for decryption keys from channel partners 502 when they are fulfilling orders, recording the number of orders, or keys distributed and reporting the number of orders to the publisher 500 to enable accurate revenue recognition.

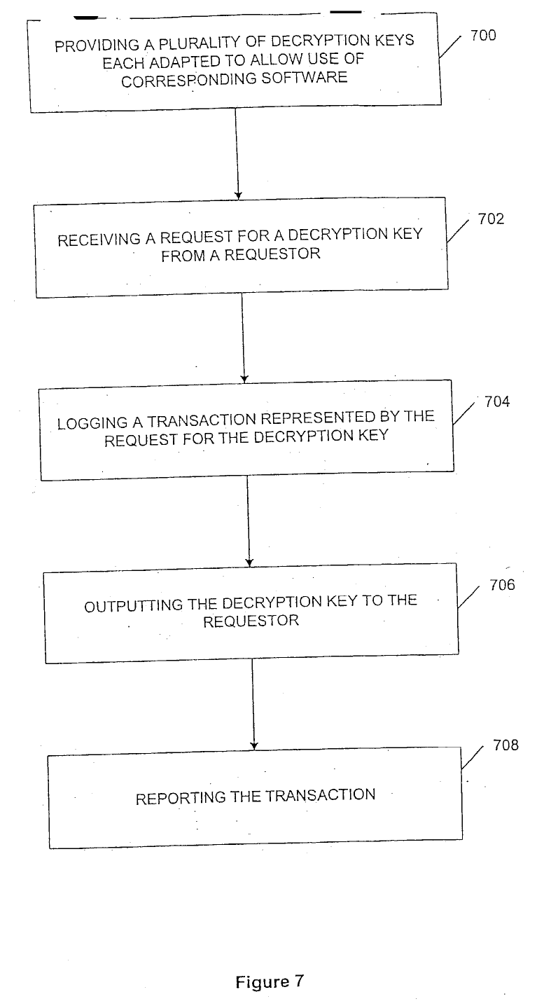

FIG. 8 illustrates yet another feature of the present invention. In particular, the present invention enables a change in traditional order of downloading and payment during distribution and sale of digital content products over a network. As shown, in operation 800, software is first provided which is encrypted at least in part. Further, in operation 802, a plurality of decryption keys are provided which are capable of decrypting the encrypted software. Next, a user is allowed to select from the encrypted software after which such selected encrypted software is downloaded. See operations 804 and 806, respectively. As an option, unencrypted software can be downloaded with the encrypted software. Examples of such software include demonstration programs or a partially operable version of the software. These can be used to allow the user to preview the software before purchasing it. The demonstration programs may also be used for marketing purposes.

The channel partner then accepts payment from the user in operation 808. Payment is accepted after both the selection and the downloading of the encrypted software. Furthermore, the amount of the payment may be determined by a profile of the user. To ensure payment, in operation 810, the decryption key is transferred to the user only after the receipt and verification of the payment. As an option, a copy of the decryption key may be stored with an identifier of the transaction. By this scheme, a user is confident that software is in his or her possession prior to delivering payment. Further, the reseller is confident of payment prior to completion of the transaction.

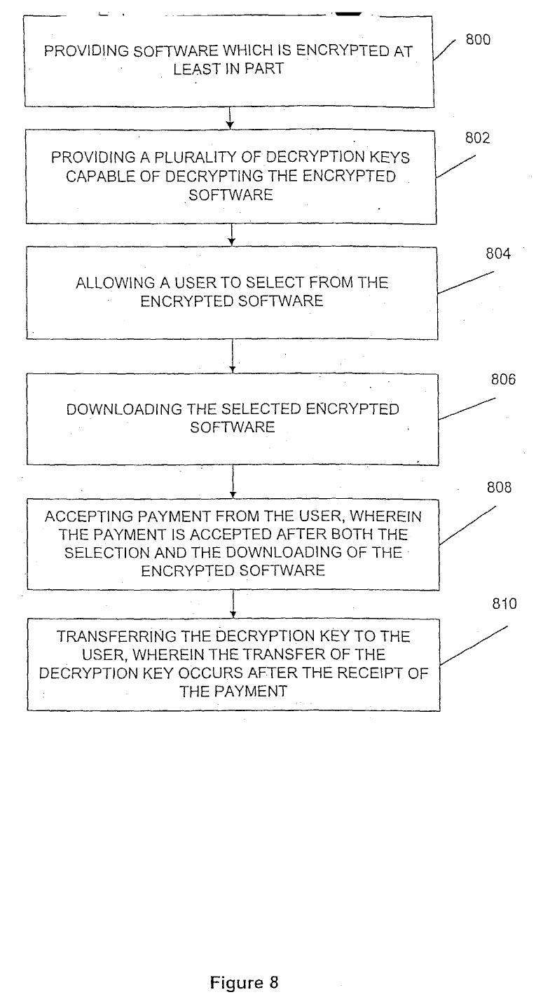

FIG. 9 illustrates yet another aspect of the present invention wherein a tailored license agreement is automatically provided during the distribution and sale of digital content products. First, a user is prompted to enter user input relating to the user in operation 900. Next, in operations 902 and 904, the user input is received over the network after which the user is allowed to select software over the network. The selected software is then downloaded over the network and a license agreement is generated utilizing the user input. Note operations 906 and 908, respectively. In one embodiment, the license agreement may be sent via electronic mail

Thereafter, the license agreement is downloaded over the network in operation 910. Upon the receipt of an acceptance of the license agreement over the network, the acceptance is stored and reported to a source of the software, i.e. publisher. Note operation 912. As an option, entitlements of the user granted under the license agreement may also be tracked. This may be accomplished through a policing routine found in the software itself, for example. The policing routine would monitor use of the software and periodically send updates to the source of the software when the user is connected to the Internet. Further, the user may be precluded from utilizing at least a portion of the software until the acceptance of the license agreement is received.

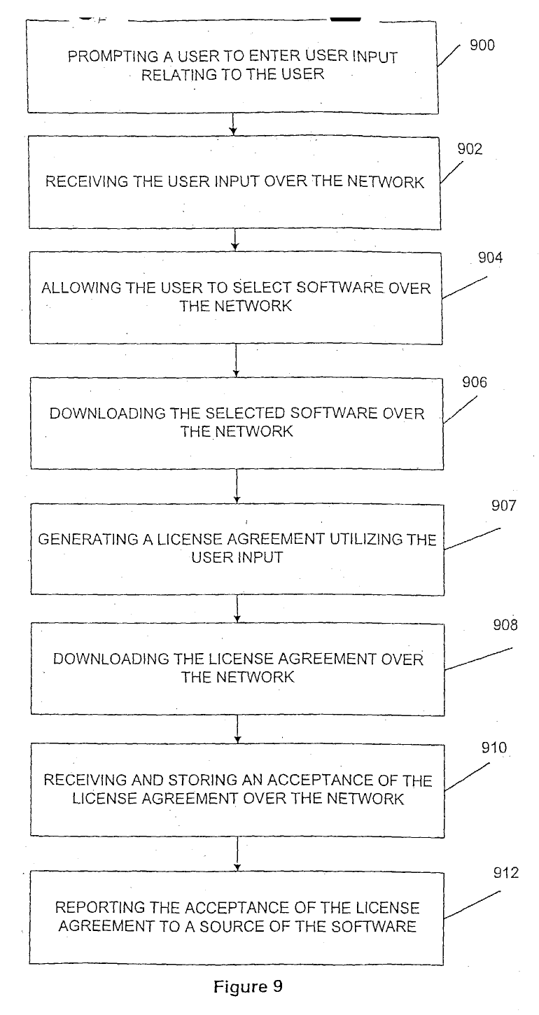

FIG. 10 illustrates an ability of the present invention to securely process a return of digital content products that were distributed electronically. This is afforded by providing a means of software source authentication over a network. As shown, software is first electronically transferred to a user over a network in exchange for payment during a transaction, as indicated in operation 1000. Then, in operation 1002, a proof-of-purchase is then downloaded over the network after the transaction. Such proof-of-purchase identifies the transaction. As an option, the proof-of-purchase may also include an identifier of a source of the software for verification. Thereafter, a notice of return including the proof-of-purchase may be received from the user over the network. See operation 1004.

The authenticity of the proof-of-purchase is verified after which a value of a refund for the return is determined, as indicated in operations 1006 and 1008, respectively. The refund is then processed in operation 1010. Optionally, information relating to the proof-of-purchase and the refund may be stored in a record. As another option, the record may be transferred to a source of the software. The identification of the user as shown on the proof of purchase could be compared to the record to ensure that the proof-of-purchase is not bogus or that the user is trying to obtain multiple refunds for the same purchase.

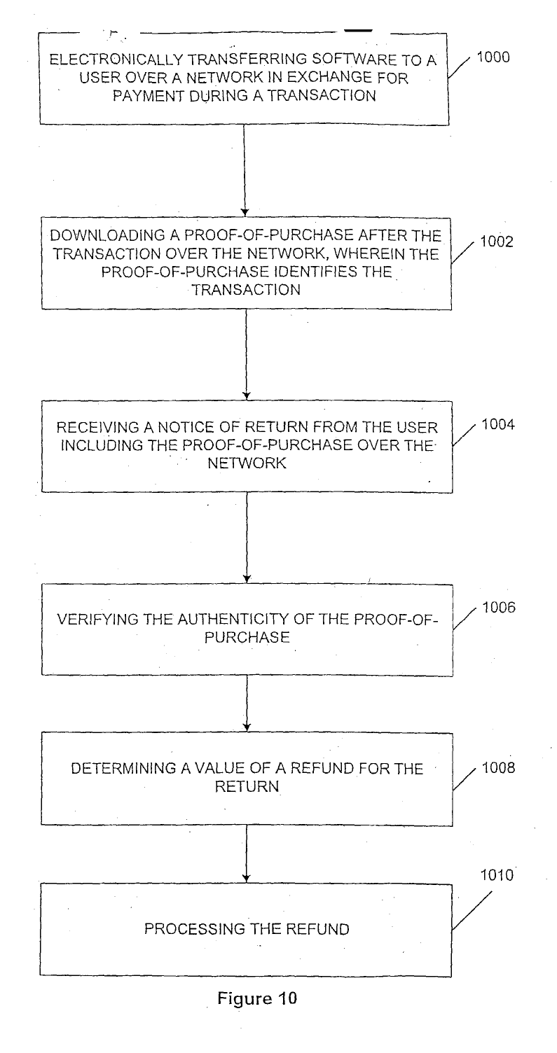

With reference now to FIG. 11, yet another aspect of the present invention is set forth. As shown, the present aspect relates to supporting electronically distributed digital content products via a profile-driven user interface. In particular, a user is first prompted to enter user input relating to the user after which the user input is received over a network, as indicated in operations 1100 and 1102, respectively. In use, a request maybe received from the user for customer support in operation 1104.

In operation 1106, a customer support-related content is then determined based on the user input. Such, customer support-related content is then transmitted to the user in operation 1108. In one embodiment, the customer support-related content may be adapted for supporting the user with respect to software. Further, the software that is being supported may also be sold over the network. As an option, the user input may include a product or service purchased by the user.

In another embodiment of the present invention, the customer support-related content may include answers to FAQ's, announcements, access to a knowledge base, product support, access to a chat room, access to newsgroups, and/or content-specific browsing. Particular content relating to each of these may be selected based on the user profile. Further, the particular content selected may be grouped with other content to provide a package of interest to the user.

Additional supporting information will now be set forth with respect to various aspects of the foregoing features of the present invention. Such enabling information relates to: receiving software from manufacture, receiving an order for the software, encrypting the software, downloading the software, providing an end user license agreement (EULA), processing a payment for the software, decrypting the software, generating a receipt for the sale, installing the software, reporting the sale, processing any returns of the software, generating a demand for the clearinghouse services, executing a recall of software, and providing customer support for the sold software.

Receive Software from Publisher

The clearinghouse receives Email notification from a publisher (notice that a new version or new product has been developed), and requests a master copy of the software. The clearinghouse receives, encrypts, and stores a master copy of the software. The clearinghouse records receipt of the master copy of software (including product #, version, etc.). The clearinghouse also supports storage of a hierarchical product structure. Also, if software ordered by a customer does not exist in the clearinghouse, the clearinghouse may obtain the master code from the publisher.

Receive Order

The clearinghouse must provide the most current product version unless requested otherwise by an end-user. All products including current and prior versions are supported and distributed by the clearinghouse. The clearinghouse receives notice of a software sale to a customer (from reseller). The clearinghouse must validate the order—including product SKU, reseller, and distributor (resellers and distributors must be approved by the publisher). All valid orders are stored within the clearinghouse. Orders can be reported upon when necessary (as requested by the publisher).

It should be noted that the order may be received in various ways, i.e. web page or any other type of customer interface. To meet this need, several companies have developed computer architectures for online electronic catalog sales using, for example, the Internet as a transport mechanism to transmit data representing purchase requests between a proprietary browser and server product pair.

For example, Netscape Communications uses its Navigator/Netsite World Wide Web (WWW) browser/server pair. A buyer uses Navigator to select a seller's Netsite server (sort of an electronic storefront), which is in turn coupled to standard application servers (back-end subsystems), e.g., a credit server or a member server for collecting demographic information on customers. These servers contain the business rules defined by the seller, e.g., what credit cards are accepted and what customer information is tracked during each sale. Some of these servers are connected to external, third-party services, e.g., the credit server to an external credit card processing network or the member server to an external demographics processing module. The actual applications e.g., on-line publishing or catalog sales, are represented as extensions of the application servers. Equivalently, the application servers are said to be instantiated in the applications. The net result of this approach is that the business rules (from the application servers) are embedded into the applications along with the application logic or presentation. Another company, Open Market, is developing a similar electronic catalog system consisting of a Hyper Text Markup Language (HTML) authoring tool (called Storebuilder), and a server (called WebServer) connected to an integrated back-end commerce system (called TransactionLink). This system appears to share similar characteristics and disadvantages as the Netscape system.

Any of the foregoing types of browsers may employed to access various databases via the Internet in order to conduct electronic commerce-related business. Typical database or file-based shopping cart systems require that the user be uniquely identified in order to associate particular data stored on the server with a particular user. This requires the user to log-in or create an account, which is then stored in the server. Each subsequent request from the user must reference the unique identifier, either in the uniform resource locator (URL) or as hidden data passed back through a form submission. Either of these approaches require that the account or ID information of the user be stored on the remote server in the network for some definite period of time. Usually, the user must keep track of the account identifier in order that the prior session information can be retrieved.

It is desirable, to the extent possible, to use existing terminal hardware appropriately adapted and modified to incorporate the principles of the present invention. Hardware suitable for this purpose is sold by NCR. This equipment, a self-service terminal system identified as model NCR 5682, incorporates the data gathering and transaction processing capabilities of conventional automated teller machines with video, graphics, audio and printer operations. Interactivity with the customer is governed by a software system through the use, for example, of a keyboard or an infrared touch screen using prompts. Transactions may be completed through the use of a credit card reader and a PIN number entering means.

In one example of a related system, insurance agents at remote office on-line terminals communicate with a central processor which includes a data bank, storing data as to risks to be insured, client information, insurance premium information and predetermined text data for incorporation into insurance contracts. An agent at a terminal keys in information regarding a risk and other data needed to write insurance for that risk. To assist him, a “form” is displayed on his terminal by the central processor, and he merely enters the pertinent information in the blanks provided. The information is correlated in the central processor, from which a premium quotation is transmitted back and displayed at the agent's terminal and in which a client data base is established with the information from the form. Errors or omissions are detected and the agent or client is notified. If the policy is to be written, a formal contract is printed under the control of the central processor and electronically stored and displayed to underwriter personnel. Concurrently the insurance contract is mailed to the client. The underwriter can decide to cancel or alter the contract. Alternatively, the underwriting function is carried out before the contract is printed and mailed. In this system, the terminals operate on-line, underwriting is performed by a human underwriter, and the insurance contract is printed remotely from the client and mailed to him. The on-line terminals are not automatic self-service vending machines; the client must deal with the company through agents.

In another example of a related system, a terminal includes a CPU and is coupled to a memory unit which has data bases storing information. Certain elements are assigned weights. The system is used by underwriters to assist them in performing their underwriting functions.

Still yet another system is adapted for automatically dispensing information, goods and services to a customer on a self-service basis including a central data processing center in which information on services offered is stored. Self-service information sales terminals are remotely linked on-line to the central data processing center and are programmed to gather information from prospective customers on goods and services desired, to transmit to customers information on the desired goods or services from the central data processing center, to take orders for goods or services from customers and transmit them for processing to the central data processing center, to accept payment, and to deliver goods or services in the form of documents to the customer when orders are completed. The central data processing center is also remotely linked to institutions, such as insurance companies, serviced by the system to keep the institution updated on completed sales of services offered by that institution. As noted, the terminals in this system are on-line with the central data processing center.

Another system is provided using self-service terminals for dispensing voice and video information, printed documents, and goods and for accepting orders and payments therefor for travel related services by currency or credit card. The self-service terminals include a processor, printer, dispenser, data sources including a mass storage unit, a card reader, a coin box, and a communication device for communicating with a remote service center. The mass storage unit stores transitory information, such as flight schedules, ticket prices, weather information and other information useful in the planning of a business trip or vacation which is periodically updated via a communication link with the remote control center. The self-service terminal normally operates off-line.

Ideally, a quantity and a price of each of the items that is selected is displayed during use of the present invention. Also displayed is a total price of the items that are selected along with shipping information. During use, the user is allowed to modify the predetermined set of items that are selected. Further, several sets of items may be separately stored for later review and modification. Retrieval of the set or sets of items should be easily accessible throughout the display catalog, such as through links.

Optionally, multiple languages may be incorporated into the present invention and payment for the predetermined set of items may be accepted in any one of a plurality of currencies such as electronic and foreign.

To allow a user to order merchandise, an alternative embodiment includes an online shopping system which allows examination, selection and order of items through a computer may be used. In such an exemplary online shopping system, in order to supplement a disadvantage by a gap from ordinary shopping caused by the use of electronic means such as not capable of directly touching the item and not capable of getting assistance of a real salesman, various devices for a user interface have been made. One of such devices is a shopping basket function which has some analogy with shopping basket used in a shop such as supermarket. In this function, items on the online shopping system are temporarily added to a purchase list and a process of order and purchase is conducted when all items to be purchased are registered on the list, as items to be purchased in the supermarket are once put into a shopping basket and lastly the account is settled at a counter. In this manner, by preparing the purchase list to order a plurality of items one time, a time required to purchase may be substantially saved. Further, the consumer may prevent the failure of shopping and stop the purchase of unnecessary items by checking the list once before the purchase. Further, there should be no feeling of easiness since the items once added on the purchase list may be finally changed in any way before the purchase, resulting in a psychological effect that the consumer may proceed shopping readily.

The elements which constitute the shopping basket are a shopping basket main body (purchase list) and a function for taking items in and out of the shopping basket. With regards to functions associated with the shopping basket, there is a function to take the items into the shopping basket (add to the purchase list), a function to check the contents of the shopping basket (display the purchase list), a function to return the item in the shopping basket (change the purchase list) and a function to purchase the items in the shopping basket. However, for the function to purchase the items, only the order is accepted because the delivery of the items is made later, except a portion of items which can be downloaded as digital data and the shopping is not completed until the items are received and the account is settled.

As regards the methods for providing the shopping basket to the consumer, there is a method of displaying a button for the shopping basket on the same display page as a catalog which the consumer watches as it is realized in the online shopping system, such as on the Internet. As another method of proving the shopping basket, there is a method for separately displaying an item catalog area and a shopping basket area. Such a function is used in the shopping system provided by a computer readable medium such as a CD-ROM.

A main stage of the online shopping is an item catalog screen on which information about the items is provided. The consumer examines the item on the screen and if he or she likes it, he or she takes it into the shopping basket, such as by placing a mouse pointer over a “purchase” button or link and clicking on the button or link. During the shopping, he or she examines the content of the shopping basket as desired to check the item scheduled to purchase and the pay amount of the items, such as by clicking on a link that brings up a screen listing all of the items selected. Accordingly, it is not necessary to always display the purchase list on the screen, but the functions to access to the shopping basket for taking in the items and to display the contents should be available to the consumer any time during the shopping.

As described above, when the button for the shopping basket is on the same page as the item catalog, the entire length of the page may change depending on the amount of item data described on the catalog. However, the page may not be accommodated on the display screen. In such a case, it is necessary for the consumer to scroll the page to display the button for the shopping basket. The same is true when the button is located at the top end of the page, and when the item of interest is at a lower portion of the page, the screen must be scrolled upward in order to take the item into the shopping basket after the confirmation. The state in which the necessary function is not displayed without scrolling not only imposes a burden to the operation of scroll, and when the consumer first uses the system, the operation to be conducted next is hard to understand and cause anxiety to the user. On the other hand, in the method of always displaying the button in a specified area by dividing the screen, the above problem is solved.

Further, as a feature of an application on the Internet, high freedom of both information provider and user is pointed out. For example, the user cannot previously limit the length of one page of the contents prepared by the information provider. The environment of the user such as a resolution of the display, a type of browser software used and the setting of font varies from user to user and the information provider cannot know it. As a result, the information provider devises the amount of information and the layout described on the page to accommodate it in the screen, though the intended effect is not always achieved depending on the environment of the user. In the method of placing the button for the shopping basket on the same page as the catalog, some degree of scrolling may be unavoidable. On the other hand, the method of dividing the screen and sharing the roles by the respective sub-areas restricts the method for preparing the contents. It may be good that the user interface is uniform in one online shop but when it is applied across a plurality of online shops of various items and scales, free design cannot be conducted. This forces on the user a specific environment such as to watch the window of the browser at a specified size.

Therefore, in accordance with the present invention, an interface for providing the shopping basket function is provided as a separate shopping basket window from a catalog window on which online shop item data is displayed. The shopping basket window is displayed on the catalog window and a display position is moved in linkage with the movement of a mouse pointer. The shopping basket includes a list of items to be purchased which is a main body of the shopping basket, a function to add the item data to the list, and a function to change the item data registered in the list. In one embodiment of the present invention, the shopping basket main body is not always displayed. Instead, an interface function to display the shopping basket contents on the screen is provided on the shopping basket window.

Package and Encrypt Software

All software encryption keys are maintained in a secure environment by the clearinghouse. The entire software encryption process must occur within the secure environment. No unencrypted software is transmitted outside of the secure environment. The clearinghouse uses a different encryption key for each SKU (instance) of product sold. The software encryption process should not affect the publication product code.

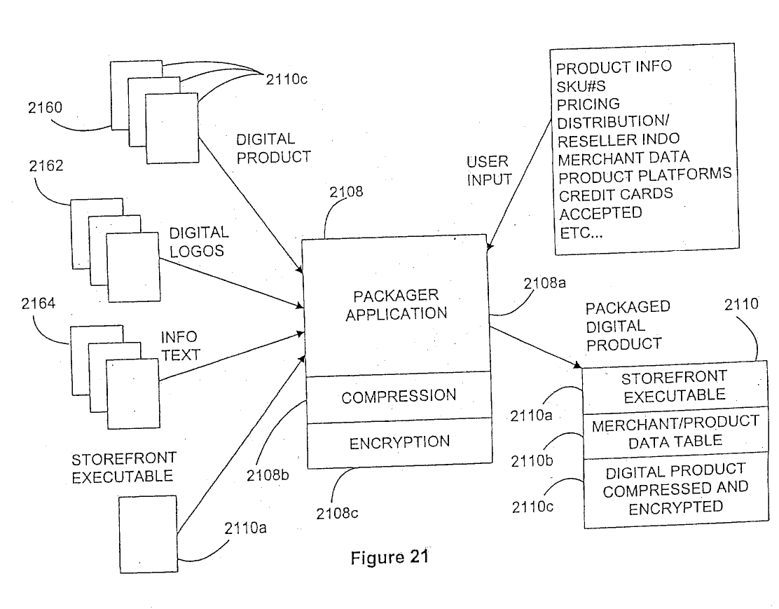

A detailed example of the packaging, encryption, decryption, and installation of software will be set forth hereinafter in greater detail with reference to FIGS. 21-24.

Download Software

The clearinghouse transmits the encrypted software to the customer's computer. For example, a secure wrapper is a secure method to deliver software electronically. Using a secure wrapper, software merchants can encase and encrypt digital content to build customizable cyber-packages without making changes to the source code. During the build process, software merchants can include bitmaps, advertisements, registration material as well as other marketing material as part of a cyber-package. After building the cyber-package, the vendor places it on the Web site where it is made available to the online consumer. Secure wrapper software securely wraps, encrypts and validates the purchase of the digital information for electronic transport from start to finish. Secure wrapper software does not require the end user to have any decryption devices residing on their system. The end user is connected to a credit card validation system via modem. If validated, the package is unlocked online.

One exemplary method for download of the software includes the following steps:

Download cyber-packaged product

Secure wrapper software scans hard drive for disk and memory space

Customer enters credit card and software registration information

Secure wrapper software records transaction data

Secure wrapper software decrypts software package after transaction approval

As long as the delivery and sales systems meet the security and reporting requirements, there are no restrictions on transports or platforms. Any digital transportation vehicle may be used including the Internet, CD ROM, proprietary networks, On-line services, television broadcast, and cable modems. The software will be virus-free.

Provide End User License Agreement (EULA)

An EULA is sent to the end-user's computer. The EULA displays terms and conditions of use of the software. The ‘signed’ EULA is received from the end-user and logged in an EULA database. The end-user name (as obtained from the EULA) is displayed during the software unpacking/unencrypting process. Agreement/licensing information on software customers may be maintained as well as sent to a source of the software. A record for each copy of software sold to an end-user may also be maintained.

The EULA is a license between the end user and the software copyright holder, which is typically the software publisher. The EULA reinforces the relationship between the end user and the software copyright holder as well as increases the end user's confidence that the software is legitimate and an approved distribution from the software copyright holder.

An EULA is “signed” when any legally recognized form of customer signature, including physical and authenticated digital indicia, is affixed or recorded on the EULA. In addition, for the EULA acceptance purposes, notation in a database of customer acceptance through an “ok” button on a screen of EULA text is an acceptable “signature” if that customer has been authenticated as having a valid credit card, expiration, and bill-to address. To comply with the “customer signed EULA” requirement, there are three primary methods the channel can use to obtain customer acceptance:

Provide the customer with a physical copy of the EULA terms and obtain physical customer signature. Archive this document.

Provide customer with a digital copy of the EULA terms and obtain an authenticatable digital customer signature (RSA public/private key type). Authenticate the signature, archive this document.

Prior to completion of the sale transaction and software delivery, display the EULA terms to the customer and receive a positive acceptance of the terms (such as through an “ok” button). Record this acceptance as part of the customer transaction history. Do not complete the customer purchase without this acceptance.

The customer must receive a copy of the EULA terms which they accept as part of the purchase process. The channel partner should deliver this to the customer in an unalterable format. Examples include facsimile, standard mail hard copy, or a digitally signed file sent over an electronic delivery method. The customer should not be able to alter (without detection) this digital copy of the EULA. One method may be to send the signed file along with the software to the customer and tell the customer in an e-mail where that file is located.

Most software vendors currently favor licensing as the preferred method of distributing software. Licensing software provides the vendor with a certain amount of control over the distributed software which may be used to the vendor's advantage. For example, licensing software allows the vendor to prohibit unauthorized usage of the software that might facilitate unauthorized copying. In addition, licensing provides an advantageous method of providing and billing for software. Through licensing, the vendor may sell several identical copies of the same software and charge the buyer for each copy.

Licensing schemes have adapted to the network environment as well as the individual personal computer. In a network environment, such as a client-server network, multiple users may access the same copy of a particular application. Consequently, the vendor can charge the network owner not for the number of copies installed on the network, but for the number of users having access to the software.

Software is conventionally licensed using an agreement between the vendor and the user or administrator. The agreement is typically either a conventionally signed contract or a “shrink wrap” agreement attached to the packaging for the software, to which the licensee acknowledges agreement by opening the package.

Although traditional licensing and shrink wrap licensing are more or less applicable to licensing for individual systems, they are not well-suited to the network environment. Both traditional and shrink wrap licensing schemes are difficult to enforce on a network where several users have access to the software. Consequently, various electronic systems have been devised for controlling access to software on a network.

Electronic licensing typically comprises providing a set of criteria under which a request for an application from the server should be granted. One licensing system uses a fixed set of licenses controlled by a license server. The license information is maintained in a license database, along with information regarding which applications are in use and how many units are still available. The information in the database may be encrypted to prevent forgeries. When an application is desired, the application commences running. Code embedded in the application initially requests a license from the server to facilitate the execution of the application. The server checks the database of licenses, and if the appropriate licenses are available, grants the request. As requests are received and licenses granted, the relevant information is logged into a file to track usage of the various applications.

If a license is not available, the client contacts another server to find the appropriate license. The client in the conventional system has the responsibility to obtain licenses from the various servers, and the individual servers provide resources at the client's request. To facilitate such licensing, the application typically includes a library of programs designed to contact the server, request a license, and track the resulting license.

When a call is made to a server, all of the execution occurs on each individual server for any particular call. Similarly, if a license is located on a particular machine, all execution necessary to operate on that license occurs on that machine. Consequently, a central server containing most of the licenses available on a particular network is mainly responsible for maintaining the licenses.

In addition, conventional licensing systems rely on code embedded in the application to establish the licensing attributes. Code is placed in the application which interprets information received from the server to establish licensing parameters. Because the behavior of the license is not established until after the request has been made and the license obtained, the user cannot read the license terms prior to the request. In addition, this system lacks flexibility. To change the licensing terms, the code in the application must be revised.

Recently, generation and sales of software programs have become significant businesses both for companies which are primarily vendors of hardware, as well as for companies which vend software alone. Software is typically sold under license, that is, vendors transfer copies of software to users under a license which governs how the users may use the software. Typically, software costs are predicated on some belief as to the amount of usage which the software program may provide and the economic benefits, such as cost saving which may otherwise be incurred, which the software may provide to the users. Thus, license fees may be based on the power of the processor or the number of processors in the system, or the number of individual nodes in a network, since these factors provide measures of the number of users which may use the software at any give time.

In many cases, however, it may also be desirable, for example, to have licenses and license fees more closely relate to the actual numbers of users which can use the program at any given time or on the actual use to which a program may be put. Furthermore, it may be desirable to limit the use of the program to specified time periods. A problem arises particularly in digital data processing systems which have multiple users and/or multiple processors, namely, managing use of licensed software to ensure that the use is within the terms of the license, that is, to ensure that the software is only used on identified processors or by the numbers of users permitted by the license.

A network environment for computers permits several computers or terminals to use or have access to one or more programs. Traditionally, an end user would have to obtain a license from a software vendor to authorize use of the vendor's software on terminals or workstations within the network.

One method for providing access to software is known as the single-CPU or single processor license, wherein a software program is locked to a specific CPU and access to that software is only permitted from the particular licensed computer. A single-CPU license may create instances where software is unavailable to all users because the computer is not functioning or because several users want to use the software at the same time. To assure wide access, end users frequently must obtain unneeded CPU-locked software to assure availability and convenience. Companies with but a few users of a particular software program generally choose a CPU-locked system because it is, in effect, priced proportionately to the number of users.

The second general method to provide access to software is known as site-licensing. With this method, a software program is available for all the computers at an installation. The number of users who may run a software package concurrently under a site license is theoretically limited only by the number of users in the computing environment. Although site-licensing may ease administrative and operational problems for an end user, it normally does so at a premium price which takes into account the lack of accountability that such flexible licensing provides. A site license imposes unneeded costs where only a few users of a company actually need the software.

In the instance where a software vendor offers a choice between CPU-locked and site licensed software, it is the number of expected users at a purchasing company which affects the purchasing choice. If many of the end users at a company intend to use the software, for example, then a site license may be the most appropriate distribution system because it may be the low-cost option. If the software only will be used by a few workers, however, then a CPU-locked distribution system may be more appropriate. The trade-off point is determined by the relative pricing between the two distribution systems.

For environments where many users need the software but only spend a portion of their time using it, neither a dedicated CPU-locked license nor a site license may be cost effective. In such a case, a user who needs more than a single copy of the software may not buy it, thus depriving a vendor of potential revenue. Similarly, vendors lose potential revenue when they permit a company with a very large number of users to use software over an entire site, due to a general lack of accountability.

As computers have proliferated in availability, the investment in computer software has also grown, and there have been developed various methods for charging the computer user for use of computer software products. Typically computer software products are licensed, rather than sold, to the computer user under various arrangements. The simplest common license arrangement gives the user the right to use a software product on a single computer, i.e., to employ only one central processing unit (CPU) in connection with operation of the software product.

Although many such licenses are for indefinite periods of time, a license may also be for a limited duration and extendable, so that the entity marketing the product can charge a periodic fee (for example, annually) for use of the software product. Or use may be absolutely time-limited (for example, one-day), so that the user may evaluate the software product for possible purchase of a regular license. Since software can be copied and moved easily from one like machine to another, companies have invented methods to prevent unauthorized use of their software products.

Some licensors require passwords to activate software on a particular machine. The password may be keyed to the hardware's identification number as a condition for operation of the software. Such systems can effectively lock software to a particular machine, but do not address software that is licensed for concurrent or simultaneous use. Some licensors use hardware locks that attach to a parallel printer port or a serial port on a machine; each time the software is activated, it looks for a specified code, in the hardware lock, as a condition for operation of the software. Using hardware locks resolves the problem of unauthorized moving of software among machines; however, hardware locks do not handle multiple software products on a single machine, and they require time and expense to deliver to the end user.

When computer software products are used in a network environment (which may include computers running in various roles as workstations and servers of various types linked together over a data path), additional licensing challenges are present. For example, a network may permit a user at one node (which may be a terminal or workstation, for instance) to utilize a software product running at another node (which may be the network server or even another workstation). Consequently, the terms of the single-computer type of software license might not cover the usage of the software product on the network, or worse still (from the point of view of the licensor) might actually permit such a usage without additional compensation to the licensor. One approach to network licensing is to grant permission to use the program based on all of the nodes on the network, and to require a license for each node. Then typically the license fee may be increased as the number of nodes on the network increases.

Another approach bases the license fee for a software product running on a network on the total number of individual users who might actually run the software, regardless of the number of nodes either on the network or running the software product at a given time. These approaches, however, have usually required the cooperation of the licensee, because additional nodes may be added to the network, or additional users may utilize the software, without the knowledge of the licensor, who is typically not present on the premises of the licensee. The licensor may reserve the right to audit the licensee's site, but such an audit is intrusive, expensive, and may alienate potential or actual customers for licenses. Although other approaches exist under which one might charge a single fee per server or per site or per entity, often on an individually negotiated basis, these approaches are often impractical or inflexible, in that they also typically do not take into account the possible wide variation over time in the number of nodes or users and also require reliance on licensee cooperation.

Recently it has become practical in some network environments to determine and limit the number of nodes that may access a software product at a given time, and to charge a license fee based on the maximum number of nodes that are permitted to use the software product concurrently.

This is called “concurrent licensing”. In these environments, a computer program, acting as “librarian” and running on a computer node designated as a license server, is typically used to distribute license keys (sometimes called “tokens”) over the network to nodes requesting access to run a software product; the number of keys is tracked by the librarian; and if at a given time, the permitted maximum number of keys would be exceeded by usage of the software product on a requesting node, the node can be denied, at such time, access to invoke the software product.

Examples of software-based concurrent licensing arrangements may be found in Unix applications running in connection with software products sold under the trademarks NetLS (available from Gradient Technologies, Inc., 577 Main Street, Suite 4, Hudson, Mass. 01749), and SunLic (available from Sun Microsystems, Inc., Mountain View, Calif.), and Flexible License Manager (available from Highland Software, Inc., 1001 Elwell Court, Palo Alto, Calif. 94303).

A preferred embodiment securely manages the integration of control information provided by two or more parties. As a result, an electronic agreement is constructed between participants creating a “negotiation” between, the control requirements of, two or more parties and enacts terms and conditions of a resulting agreement. Further, the rights of each party to an electronic agreement regarding a wide range of electronic activities related to electronic information and/or appliance usage is assured.

Electronic Agreements and Rights Protection

An important feature of the present invention is that it can be used to assure the administration of, and adequacy of security and rights protection for, electronic agreements implemented through the use of the present invention. Such agreements may involve one or more of:

(a) creators, publishers, and other distributors, of electronic information,

(b) financial service (e.g. credit) providers,

(c) users of (other than financial service providers) information arising from content usage such as content specific demographic information and user specific descriptive information. Such users may include market analysts, marketing list compilers for direct and directed marketing, and government agencies,

(d) end users of content,

(e) infrastructure service and device providers such as telecommunication companies and hardware manufacturers (semiconductor and electronic appliance and/or other computer system manufacturers) who receive compensation based upon the use of their services and/or devices, and

(f) certain parties described by electronic information.

The present invention supports commercially secure “extended” value chain electronic agreements. The present invention can be configured to support the various underlying agreements between parties that comprise this extended agreement. These agreements can define important electronic commerce considerations including:

(a) security,

(b) content use control, including electronic distribution,

(c) privacy (regarding, for example, information concerning parties described by medical, credit, tax, personal, and/or of other forms of confidential information),

(d) management of financial processes, and

(e) pathways of handling for electronic content, content and/or appliance control information, electronic content and/or appliance usage information and payment and/or credit.

The present invention may define the electronic commerce relationship of two or more parties of a value chain, but such agreements may, at times, not directly obligate or otherwise directly involve other value chain participants. For example, an electronic agreement between a content creator and a distributor may establish both the price to the distributor for a creator's content (such as for a property distributed in a container object) and the number of copies of this object that this distributor may distribute to end-users over a given period of time.

In a second agreement, a value chain end-user may be involved in a three party agreement in which the end-user agrees to certain requirements for using the distributed product such as accepting distributor charges for content use and agreeing to observe the copyright rights of the creator. A third agreement might exist between the distributor and a financial clearinghouse that allows the distributor to employ the clearinghouse's credit for payment for the product if the end-user has a separate (fourth) agreement directly with the clearinghouse extending credit to the end-user.

A fifth, evolving agreement may develop between all value chain participants as content control information passes along its chain of handling. This evolving agreement can establish the rights of all parties to content usage information, including, for example, the nature of information to be received by each party and the pathway of handling of content usage information and related procedures. A sixth agreement in this example, may involve all parties to the agreement and establishes certain general assumptions, such as security techniques and degree of trustedness (for example, commercial integrity of the system may require each installation secure subsystem to electronically warrant that their node meets certain interoperability requirements). In the above example, these six agreements could comprise agreements of an extended agreement for this commercial value chain instance.

Some agreements support evolving (“living”) electronic agreement arrangements that can be modified by current and/or new participants through very simple to sophisticated “negotiations” between newly proposed content control information interacting with control information already in place and/or by negotiation between concurrently proposed content control information submitted by a plurality of parties. A given model may be asynchronously and progressively modified over time in accordance with existing senior rules and such modification may be applied to all, to classes of, and/or to specific content, and/or to classes and/or specific users and/or user nodes. A given piece of content may be subject to different control information at different times or places of handling, depending on the evolution of its content control information (and/or on differing, applicable installation content control information).

The evolution of control information can occur during the passing along of one or more control information containing objects, that is control information may be modified at one or more points along a chain of control information handling, so long as such modification is allowed. As a result, managed content may have different control information applied at both different “locations” in a chain of content handling and at similar locations in differing chains of the handling of such content. Such different application of control information may also result from content control information specifying that a certain party or group of parties shall be subject to content control information that differs from another party or group of parties. For example, content control information for a given piece of content may be stipulated as senior information and therefore not changeable, might be put in place by a content creator and might stipulate that national distributors of a given piece of their content may be permitted to make 100,000 copies per calendar quarter, so long as such copies are provided to bonafide end-users, but may pass only a single copy of such content to a local retailers and the control information limits such a retailer to making no more than 1,000 copies per month for retail sales to end-users. In addition, for example, an end-user of such content might be limited by the same content control information to making three copies of such content, one for each of three different computers he or she uses (one desktop computer at work, one for a desktop computer at home, and one for a portable computer).

Electronic agreements supported by the preferred embodiment of the present invention can vary from very simple to very elaborate. They can support widely diverse information management models that provide for electronic information security, usage administration, and communication and may support:

(a) secure electronic distribution of information, for example commercial literary properties,

(b) secure electronic information usage monitoring and reporting,

(c) secure financial transaction capabilities related to both electronic information and/or appliance usage and other electronic credit and/or currency usage and administration capabilities,

(d) privacy protection for usage information a user does not wish to release, and

(e) “living” electronic information content dissemination models that flexibly accommodate:

(1) a breadth of participants,

(2) one or more pathways (chains) for: the handling of content, content and/or appliance control information, reporting of content and/or appliance usage related information, and/or payment,

(3) supporting an evolution of terms and conditions incorporated into content control information, including use of electronic negotiation capabilities,

(4) support the combination of multiple pieces of content to form new content aggregations, and

(5) multiple concurrent models.

Process Payment

The customer may be provided with means to enter billing information. An example would include providing an on-line form which accepts user indicia relating to a billing address.

Payment for the software purchased over the Internet is one aspect of the present invention. Today, approximately 350 billion coin and currency transactions occur between individuals and institutions every year. The extensive use of coin and currency transactions has limited the automation of individual transactions such as purchases, fares, and bank account deposits and withdrawals. Individual cash transactions are burdened by the need to have the correct amount of cash or providing change therefor. Furthermore, the handling and managing of paper cash and coins is inconvenient, costly and time consuming for both individuals and financial institutions.

Although checks may be written for any specific amount up to the amount available in the account, checks have very limited transferability and must be supplied from a physical inventory. Paper-based checking systems do not offer sufficient relief from the limitations of cash transactions, sharing many of the inconveniences of handling currency while adding the inherent delays associated with processing checks. To this end, economic exchange has striven for greater convenience at a lower cost, while also seeking improved security.

Automation has achieved some of these qualities for large transactions through computerized electronic funds transfer (“EFT”) systems. Electronic funds transfer is essentially a process of value exchange achieved through the banking system's centralized computer transactions. EFT services are a transfer of payments utilizing electronic “checks,” which are used primarily by large commercial organizations.

The Automated Clearing House (“ACH”) where a user can enter a pre-authorized code and download information with billing occurring later, and a Point Of Sale (POS) system where a transaction is processed by connecting with a central computer for authorization for the transaction granted or denied immediately are examples of EFT systems that are utilized by retail and commercial organizations.

Home Banking bill payment services are examples of an EFT system used by individuals to make payments from a home computer. Currently, home banking initiatives have found few customers. Of the banks that have offered services for payments, account transfers and information over the telephone lines using personal computers, less than one percent of the bank's customers are using the service. One reason that Home Banking has not been a successful product is because the customer cannot deposit and withdraw money as needed in this type of system.

Current EFT systems, credit cards, or debit cards, which are used in conjunction with an on-line system to transfer money between accounts, such as between the account of a merchant and that of a customer, cannot satisfy the need for an automated transaction system providing an ergonomic interface. To implement an automated, convenient transaction that can dispense some form of economic value, there has been a trend towards off-line payments. For example, numerous ideas have been proposed for some form of “electronic money” that can be used in cashless payment transactions as alternatives to the traditional currency and check types of payment systems.

The more well known techniques include magnetic stripe cards purchased for a given amount and from which a prepaid value can be deducted for specific purposes. Upon exhaustion of the economic value, the cards are thrown away. Other examples include memory cards or so called smart cards which are capable of repetitively storing information representing value that is likewise deducted for specific purposes.

It is desirable for a computer operated under the control of a merchant to obtain information offered by a customer and transmitted by a computer operating under the control of the customer over a publicly accessible packet-switched network (e.g., the Internet) to the computer operating under the control of the merchant, without risking the exposure of the information to interception by third parties that have access to the network, and to assure that the information is from an authentic source. It is further desirable for the merchant to transmit information, including a subset of the information provided by the customer, over such a network to a payment gateway computer system that is designated, by a bank or other financial institution that has the responsibility of providing payment on behalf of the customer, to authorize a commercial transaction on behalf of such a financial institution, without the risk of exposing that information to interception by third parties. Such institutions include, for example, financial institutions offering credit or debit card services.

Such secure payment technologies include the industry standard Secure Electronic Transactions (SET) protocol recently announced by Visa, MasterCard and their technology partners, including Microsoft. Other secure payment technologies include Secure Transaction Technology (“STT”), Secure Electronic Payments Protocol (“SEPP”), Internet Keyed Payments (“iKP”), Net Trust, and Cybercash Credit Payment Protocol. One of ordinary skill in the art readily comprehends that any of the secure payment technologies can be substituted for the SET protocol without undue experimentation. Such secure payment technologies require the customer to operate software that is compliant with the secure payment technology, interacting with third-party certification authorities, thereby allowing the customer to transmit encoded information to a merchant, some of which may be decoded by the merchant, and some which can be decoded only by a payment gateway specified by the customer.

Another such attempt to provide such a secure transmission channel is a general-purpose secure communication protocol such as Netscape, Inc.'s Secure Sockets Layer (hereinafter “SSL”), as described in Freier, Karlton & Kocher (hereinafter “Freier”), The SSL Protocol Version 3.0, March 1996, and hereby incorporated by reference. SSL provides a means for secure transmission between two computers. SSL has the advantage that it does not require special-purpose software to be installed on the customer's computer because it is already incorporated into widely available software that many people utilize as their standard Internet access medium, and does not require that the customer interact with any third-party certification authority. Instead, the support for SSL may be incorporated into software already in use by the customer, e.g., the Netscape Navigator World Wide Web browsing tool. However, although a computer on an SSL connection may initiate a second SSL connection to another computer, a drawback to the SSL approach is each SSL connection supports only a two-computer connection. Therefore, SSL does not provide a mechanism for transmitting encoded information to a merchant for retransmission to a payment gateway such that a subset of the information is readable to the payment gateway but not to the merchant. Although SSL allows for robustly secure two-party data transmission, it does not meet the ultimate need of the electronic commerce market for robustly secure three-party data transmission. Other examples of general-purpose secure communication protocols include Private Communications Technology (“PCT”) from Microsoft, Inc., Secure Hyper-Text Transport Protocol (“SHTTP”) from Terisa Systems, Shen, Kerberos, Photuris, Pretty Good Privacy (“PGP”) which meets the IPSEC criteria. One of ordinary skill in the art readily comprehends that any of the general-purpose secure communication protocols can be substituted for the SSL transmission protocol without undue experimentation.

Banks desire an Internet payment solution that emulates existing Point of Sale (POS) applications that are currently installed on their host computers, and require minimal changes to their host systems. This is a critical requirement since any downtime for a banks host computer system represents an enormous expense. Currently, VeriFone supports over fourteen hundred different payment-related applications. The large number of applications is necessary to accommodate a wide variety of host message formats, diverse methods for communicating to a variety of hosts with different dial-up and direct-connect schemes, and different certification around the world. In addition, there are a wide variety of business processes that dictate how a Point of Sale (POS) terminal queries a user for data and subsequently displays the data. Also, various vertical market segments, such as hotels, car rental agencies, restaurants, retail sales, mail sales/telephone sales require interfaces for different types of data to be entered, and provide different discount rates to merchants for complying with various data types. Moreover, a plethora of report generation mechanisms and formats are utilized by merchants that banking organizations work with.

Banks are unwilling to converge on “standards” since convergence would facilitate switching from one acquiring bank to another by merchants. In general, banks desire to increase the cost that a merchant incurs in switching from one acquiring bank to another acquiring bank. This is accomplished by supplying a merchant with a terminal that only communicates utilizing the bank's proprietary protocol, and by providing other value-added services that a merchant may not be able to obtain at another bank.

Internet-based payment solutions require additional security measures that are not found in conventional POS terminals. This additional requirement is necessitated because Internet communication is done over publicly-accessible, unsecured communication line in stark contrast to the private, secure, dedicated phone or leased line service utilized between a traditional merchant and an acquiring bank. Thus, it is critical that any solution utilizing the Internet for a communication backbone, employ some form of cryptography.

As discussed above, the current state-of-the-art in Internet based payment processing is a protocol referred to as SET. Since the. SET messages are uniform across all implementations, banks cannot differentiate themselves in any reasonable way. Also, since SET is not a proper superset of all protocols utilized today, there are bank protocols which cannot be mapped or translated into SET because they require data elements for which SET has no placeholder. Further, SET only handles the message types directly related to authorizing and capturing credit card transactions and adjustments to these authorizations or captures. In a typical POS terminal in the physical world, these messages comprise almost the entire volume of the total number of messages between the merchant and the authorizing bank, but only half of the total number of different message types. These message types, which are used infrequently, but which are critical to the operation of the POS terminal must be supported for proper transaction processing.

Decrypt Software

The clearinghouse may either send a software decryption key (or provide some other mechanism to allow customer to decrypt) to a customer or decrypt the software before upload to the customer. The clearinghouse should maintain a secure list of valid software decryption key capable of unlocking all encrypted software and include the customers to which keys are sent. The clearinghouse may wait for a request for the decryption key from a customer or from a reseller who sold the encrypted software. Before or after sending the key, the clearinghouse reports the transaction to the publisher.

Two different communication methods which are routed over different pathways to the customer's desktop may be used. For example, if one is selling over the Internet, he or she may choose to download the encrypted bag of bits to the customer desktop using a Multipurpose Internet Mail Extension (MIME) session. MIME is a set of specifications that provides a way to interchange text with different character sets. MIME also allows the sending of multi-media e-mail. MIME allows e-mail messages to contain images, sounds, character sets other than US-ASCII, enriched text, other messages (reliably encapsulated), tar files, PostScript, and pointers to FTPable files, among other things.

The key to unlock that archive must not be sent during the same session. It should be sent over a different communication method to the customer. For example e-mail, fax, or telephone. The basic concept here is to prevent a casual hacker from being able to get both the lockbox and the key to that box without a lot of effort.

Where a software locking and unlocking scheme is used as part of the distribution channel for Microsoft Software, it has to be sufficiently robust to have solved the one key fits many locks problem. Keys have to be unique to each sale instance of the software. There can be generic delivery archives, but only one key per instance of sale. Once a key is used, it must not be able to be used again with another lock. One way to implement this concept is to use some customer or CPU specific information during the unlocking process to ensure uniqueness of the transaction. Another implementation may put time limits on key use and re-use.

For unlocking and authorization, any of the digital transport methods may be used or any other communication device including e-mail, telephone, fax, or pager.

A detailed example of the packaging, encryption, decryption, and installation of software will be set forth hereinafter in greater detail with reference to FIGS. 21-24.

Generate Receipt

A proof of purchase receipt is downloaded to the customer's computer. The customer may be provided a means by which to save receipt on their computer. Optionally, a software publishers certificate may be provided to customer to verify authenticity of downloaded software (if deemed necessary by the publisher).

The channel must provide the customer an unalterable proof of purchase document. This may be in the form of a digitally signed receipt document which is sent by e-mail to the customer. The general requirement is that the customer must receive something from the channel which proves they purchased the product, but cannot be altered by them (without detection) so other channel partners have confidence in its authenticity.

As an option, a replacement mechanism may be provided in order to handle the situation where a back-up copy is required. In one embodiment, the decryption key may be used for this purpose..

Install Software

If necessary, the software must be unpacked or decompressed. One example would be to seamlessly run a software's ‘set-up’ process to complete a software installation.

A detailed example of the packaging, encryption, decryption, and installation of software will be set forth hereinafter in greater detail with reference to FIGS. 21-24.

Report Sale

A daily transaction report reflecting all product orders and returns is produced, as are audit trail reports. Other publisher-defined reports may also be produced.

Process Return

In the event a product is to be returned, the clearinghouse would receive notice of the return from reseller and validate that the product has been or is being returned. One way to validate that the product has been returned is to require the user to provide both a proof-of-purchase and signed letter of software destruction before the clearinghouse can process the return. The proof of purchase can be easily verified as authentic if it was of the unalterable type set forth above. Otherwise, a serial number on the proof of purchase and name of the user can be compared to sales records. Signed means a document authenticated by its author in a non-repudiatable manner. For example, a wet ink manual signature on a piece of paper is a signed document. Another example is a digital message signed by a public key certificate issued by a recognized certificate authority.

Another way to validate that the product has been returned would be to actually connect with the customer's computer and remove a vital portion of the program making it unusable, or deleting the entire program altogether.

Once the software has been returned, a value is placed on the return. For example, if the software is returned before a decryption key is sent to the customer, a full refund may be given. If the customer has used the software for more than a predetermined period, only a partial refund may be given or no refund at all.

In the EULA database, it will be indicated that the customer's software has been returned. Only one software return per EULA should be allowed to prevent fraud. The clearinghouse will have full ESD customer level transaction data and will report this by channel partner to the publisher on a periodic basis such as hourly, daily, weekly or monthly basis. This periodic report will be checked against the channel purchase orders to ensure that the channel is reporting all transactions properly.

The clearinghouse may also report customer information, such as the customer's profile, that was collected as part of the transaction, to the software publisher.

If the reseller who sold a product is out of business, a special procedure may be carried out. On the customer's Unalterable Proof of Purchase will be the chain of handling which the sale went through. The customer should contact the distributor noted on the document. Since customer transaction history is stored at the clearinghouse level, the customer should be able to return the product to any member of the distribution chain served by that clearinghouse, although the preferred return path is the initial reseller.

In a fully electronic channel using “strong encryption” techniques, it is possible to significantly reduce the ability of any pirate to pose as a manufacturing site and insert bogus product into the channel. The ESD channel should be designed with very strong technical barriers and checks and balances in such a way that this form of piracy should be eliminated.

Generate Demand for Clearinghouse Services (Advertising, etc.)

An important aspect of distributing products is generating a demand for those products. Content must be acquired to be distributed through the ESD. To acquire content, however, software publishers must become clients. Mass marketing to resellers, distributors and other potential customers may be necessary to ensure a large volume of content is moved through the ESD. At the customer level, the product is advertised, a pricing scheme is determined, and product trials are offered which allow a customer to download a working version of the software that only has a few selected features.

In an alternate embodiment, the publisher 500 can perform any or all ESD channel partner 502 functions. Since there is no longer a one-to-one relationship between the number of units shipped by the publisher and the number of units sold or returned, or in channel consignment inventory in an ESD system, then the publishers face a risk of under-reporting of sales.

With the increasing popularity of computer communications, many companies are becoming interested in advertising and supporting their products using an online computer service that can be accessed by customers. However, creating a large online computer service is an extensive task. To develop a sophisticated online service, such as America Online™, CompuServe™, Genie™, or Prodigy™, a company must have a large mainframe computer and customized software. Developing the customized software requires a competent programming staff and a good deal of time. Most companies do not have the resources required to develop such systems, and thus cannot easily develop and maintain an online presence.

One way a company can contact millions of potential customers is to use the Internet. The Internet is a network of computer networks that links together millions of computer systems using the well defined TCP/IP protocol.

One method of distributing and viewing information is on the Internet. A browser program retrieves the formatted information and provides the information in an appropriate manner to the user. For example, the client browser program displays graphical image information as images on the user's graphical display screen; plays video information as video animation on the user's graphical display screen; displays text information as text on the user's screen; and plays sound samples using the speakers on the user's computer system. Microsoft Internet Explorer, one popular client browser program, is widely available to the users of the global Internet.

For a company that wishes to develop an online presence, creating an internet site would provide a feature rich online service available to customers and clients. An internet site can display images, text, animation, and sounds that provide information about the company. Furthermore, internet sites can be implemented on relatively simple computer systems, including personal computers.

Alternatively, a company can deploy a HTTP server that is available to customers through dial-up phone service. A dial-up HTTP server would be accessible to customers and clients that do not have Internet access. Thus, by creating a simple HTTP server, any organization or corporation can create an online presence.

However, quickly creating the HTML formatted documents required for a World-Wide Web Server is not a trivial task. Moreover, the standard HTTP server software, without any additional programming, is very limited. For example, without custom extensions, an HTTP server cannot accommodate complex transactions between a user and the HTTP server or integrate a database system into an online service. Although it is possible to write custom extensions to the HTTP server software using a conventional programming language, such custom extensions are difficult to write except by experienced programmers. Thus, to be able to quickly deploy full-featured HTTP servers, it would be desirable to have a development tool usable by non-programmers that allows a developer to quickly and easily create a full-featured online service based upon the HTTP and HTML standards.

Many programming development tools are known in the art. These programming development tools range from tools which are developed and marketed as general purpose programming development tools to sophisticated special purpose development tools for developing specific types of applications.

For example, the Information Exchange Facility (IEF) general development tool, which is available from Texas Instruments, is used by professional programmers to develop application programs. Essentially, IEF provides a facility that allows a programmer to write “pseudo code” and IEF generates an intermediate source code program in a high level programming language (such as COBOL or C code) based on the “pseudo code”. IEF is an example of what will be referred to herein as a “general purpose development tool” because it allows development of programs for essentially any purpose or application dependent on the input provided by the programmer.

In contrast to general purpose software development tools, many application programs themselves provide special purpose “development tool” capability. An example is the Access™ database program available from Microsoft. The Access™ database allows end users to develop sophisticated database applications which would have been developed by professional programmers a few years ago. The Access™ database is but one example of a special purpose development tool.

Another example of a special purpose development tool is the Application Development Environment of Lotus Notes™. The Application Development Environment of Lotus Notes provides features which are said to allow for rapid development of workgroup applications such as sharing of documents between users over a network. Generally, Lotus Notes and, thus, its Application Development Environment, is directed at sharing of documents among persons in an authorized work group.

The Lotus Notes Application Development Environment provides for such features as (i) application design templates which are said to allow sophisticated applications to be built by customizing pre-built applications such as document libraries, form-based approval systems, project tracking applications and status reporting systems; (ii) security; (iii) database access; and (iv) discussion groups.

Recall

From time to time, a company may issue a recall on some code which has been distributed in the channel. Or as part of an upgrade process, may offer to take back a prior version inventory in the channel. This is a complicated and expensive process when dealing with boxes, but quite simple in the ESD model. The channel does not pre-purchase inventory for ESD. The software masters are not useable until the rights are sold with them. To make an ESD software master obsolete in the ESD channel can be done by simply setting a flag in the rights database at the authorized clearinghouse to obsolete. When someone tries to unlock or purchase the rights for an obsolete version, they should be directed to the current one. The channel will not have anything to return to the company.

Provide Customer Support

Customer support may be provided to customers via phone, email and fax, for example. Customer support should include (but not limited to) helping customers with: problems with software download; problems with decryption/unpacking processes; problems with software set-up; procedural questions (including instructions for downloading and/or returning software). Feedback should be provided to the customer on any potential delays with a software purchase.

Customer support may also manage customer relationships. Managing customer relationships includes receiving customer feedback. Software publishers and channel partners can use customer feedback to improve the products and services over time.

The customer support features are supported by an internet/intranet application to assist in solving many of the problems encountered by both customers and the customer support organization itself. The customer support application provides a mechanism with which companies can utilize servers to establish an internal or external Web-based customer support function. The customer interface is based on the premise of self-navigation. Customers can visit the site and find answers to their support problems through searches of the knowledge base and Frequently Asked Questions (FAQs). If the customer is unable to find the answer to their question they will be able to submit a support incident to the product support database.

This application reduces the time and expenses associated with direct contact with a call center phone representative. As more organizations enable their employees to access the Internet and their own corporate Intranets, the benefits of a Web based support application increases. The support application can be used for both internal and external customer support, alleviating much of the strain on both internal and external support/helpdesk organizations.

The customer support application features include:

Personalized site based on customer profile

Ability to search the knowledge base and browse FAQs

Support for announcements or “hot topics” personalized to the customer's products and/or interests

Support for peer-to-peer newsgroups

Support for customer interaction with other customers and support personal questions via chats

Administrative support to set access privileges

Administrative ability to create and modify products and related links, queries, etc.

Customer ability to submit support requests or comments

Customer service personnel ability to view and respond to customer reported incidents

The customer support application aids customers in answering their support questions by providing answers immediately online or by allowing the customer to submit comments or incidents directly to the product support database. This is accomplished by providing personalized access and navigation to different data sources, including, chat, news, mail, and a search engine.

The customer support application is focused on three main entities: the customer, the support representative and the site administrator. Key features to be provided for each of these entities are described below.

To answer their questions and get support online, the customer will be able to:

Receive personalized support

Receive personalized general and product-specific announcements

Enter profile information listing products, interests, etc.

Browse general and product-specific FAQ's

Search the product knowledge base

Participate in general and product-specific chats

Browse general and product-specific newsgroups

Provide feedback on the site

Submit and track comments or support requests

Link to the organization's “Home” Web site

Select specific chat clients

Record and display select chat transcripts

Send feedback on the site

Product registration

Validation against existing customer or registration databases

Ability to recognize the same customer from multiple machines

Pay per product support

Entitlements

View a schedule of upcoming/future (or regularly scheduled) chat forums, office hours, etc.

Personalization is the key to the customer's experience with the customer support application. Personalization allows customers to set up their own support profile containing product and service information. The personalization will allow the customer to access the customer support content without having to search through all of the products or services offered by the company. When a customer first visits the customer support site, the customer will be presented a choice of products and services to help build the customer's personal profile. Subsequent visits to the customer support site will be granted based on the identity of the customer. The personalized customer support page is dynamically built based on the previously entered personal profile.

The personalization component is used to further aid the navigation of the other data sources: mail, chat, news, context-specific browsing and a full text search.

The personalized “Home” support page contains announcements pertaining to the products the customer has identified in his personal profile. The announcement section also contains general information from the support organization intended for all customers. When a customer selects an individual product for support, the announcement section will be updated to include announcements specific to that product.

Context searching through the FAQ data source provides the customer additional navigational assistance in finding an answer to their problem. Rather than presenting the customer with a blank prompt box and hoping they enter the correct search criteria, navigational assistance guides the customer to the correct answer by allowing the customer to select from predefined search queries. For example, a customer may have set Microsoft Excel as a product of interest within their personalization profile. When accessing the context search area, a list of Excel topics (Printing, Formatting, Saving) may appear that are only applicable to the current product. Choosing one of these topics sends a predefined query to a search engine, to return a more refined result set. This should reduce the number of returned values in the result list, and aid the customer in quickly finding their answer.

The relationship between the product and the available sub-topics and queries for that product is built as a site administrator function. The relationship is available within the context of a certain product. The site administrator places a link to the appropriate FAQ data source. Not all support sites will have FAQs. A customer may utilize his web browser to browse FAQs.

A full text search function is provided as an aid to more advanced customers who are familiar with the terminology and the exact content they are seeking. Upon entering the desired search text, this information is passed to a search engine and links are returned to the appropriate documents. This is accessible from the home, or top level of the site. Search tips will also be provided to assist with building the search query statement.

The site administrator places a link to the appropriate knowledge base (database, HTML, or documents). Not all support sites will have a knowledge base search function.

The product support function will allow the customer to submit an incident (e.g.: issue, bug, comment, or request) to the product support database.

If the customer's questions are not answered through the search of the knowledge base and FAQs, an incident form is automatically provided for submitting comments or issues. The information collected on this form is captured in the incident database for review by a support representative as well as for archival purposes. Customers are presented with instructions for accessing the other options and solutions available for answering their questions before the incident form is displayed.

The incident form contains customer information (name, address, e-mail address) defaulted from the customer's profile and with the specific product selected before arriving at the support page.

Incident Tracking

Customers can view the incidents they have submitted. The view is generated from the incident database. Customers will see the incident number, description, status, resolution type and whether e-mail was sent to the customer by a support representative. The oldest incident to be displayed will be determined by the site administrator. Default time values may be selected by the site administrator.

Chats

The customers may be provided access to chat forums. Chat forums may be open peer-to-peer interactions, or be hosted by a particular product group, allowing focused discussions at particular times, such as during “office hours”. Chats provide an interactive forum to enable customers to help themselves, creating a self-help community of knowledgeable customers. When the chat area is accessed from the top level of the site, general support chats are available. When accessed from within the context of a product, forums appropriate for that product are available.

The customer support application provides instructions for accessing the chat using the customer's own browser. This information also includes the chat server and chat channel names. The application also displays available chat descriptions, names, and active customers participating in the chat. The site administrator creates the chats and chat links. Not all support sites will have a chat function.

Newsgroups

Customers can access newsgroups available for the product profile they have chosen. For example, if a customer has selected Microsoft Excel in their profile, accessing the Newsgroups area generates a list of newsgroups appropriate for Excel. When the Newsgroup area is accessed from the top level of the site, all available general newsgroups will be listed.

Customer Interface

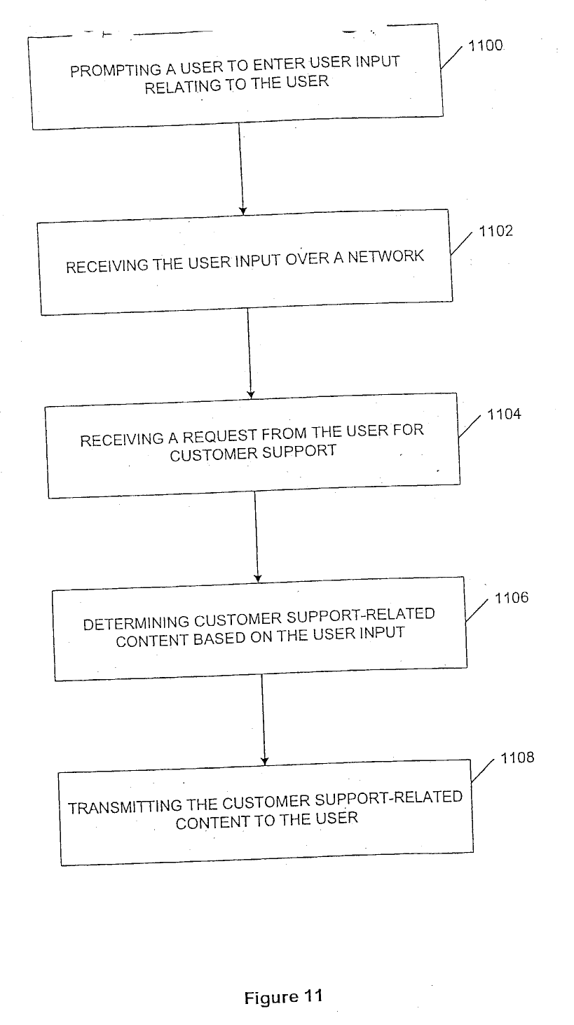

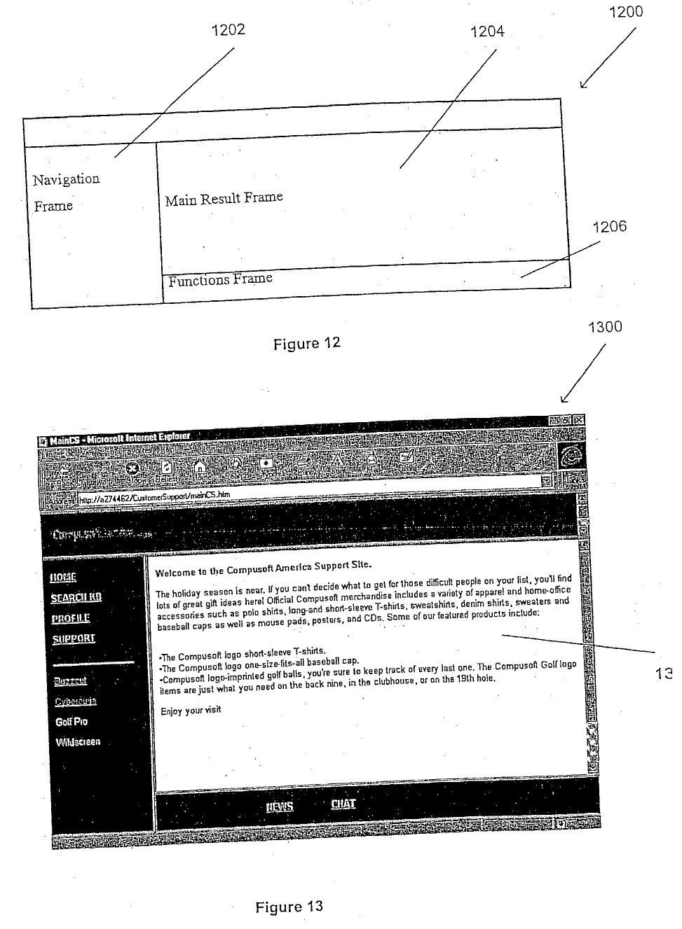

The customer interface for the customer area is based on a frame format 1200 shown in FIG. 12. A specific implementation of a customer interface 1300 is shown in FIG. 13. A plurality of frame descriptions will now be set forth:

Navigation Frame

A navigation frame 1202 contains the general site navigation controls, links and any products selected in the customer profile. General links include:

Home—a link to return to the support site home page

Search KB—to search the knowledge base for any type of information

Profile—to modify the customer's existing profile data or add and remove products

Support—to view previously submitted issues

Main Result Frame

A main result frame 1204 may contain the results from knowledge base or FAQ searches, chat, online forms, site announcements, and generally the result of any function selected from the navigation or function frames.

Functions Frame

The functions frame 1206 contains links to different functions depending on the current context chosen in the navigation frame. If ‘Home’ is selected in the navigation frame, the appropriate functions are available in the functions frame, such as News and Chat. If a specific product is chosen from the navigation frame, function links for Browse FAQ, News, Chat, and Product Support (email) are available.

Several pages may be provided to assist the customer's use of the customer support features. Exemplary pages include:

Profile New Customer

If the customer has not visited the site previously, as determined by asking for a password or a user ID and comparing that input to a database, a form appears asking them to enter profile information. This includes name, address, city, state, zip, country, company, phone, email, products, etc. This form appears in a main result frame. The customer clicks a button to submit the profile information and proceeds to the now customized Home page.

Home

Shown in FIG. 13, first time customers are presented with first time customer announcements 1302. Return customers are presented with general site announcements and links to customized content for their chosen products. Site announcements appear in the main results frame, and the product links are appended to the list in the navigation frame. Selecting a product link generates product specific announcements and updates the functions frame with any new available functions.

Search Knowledge Base (KB)

A search prompt box appears in navigation frame, in addition to any appropriate links including Search Tips. After entering search criteria, search results are displayed in the main result frame. The customer can click on a document link to view the knowledge base article.

Profile

The profile function allows the customer to change their previously defined profile. This would allow the customers to change their name, address, city, state, zip, country, company, phone, e-mail and products selected. The customer would then click on a button to submit the profile information and proceed back to the Home page.

Support

Previously submitted incidents can be viewed by the customer under this function. It contains a list of incidents along with the current status, resolution and whether an email has been sent.

General News

Available newsgroups appear in the main result frame. Selecting a newsgroup link launches the customers default newsreader to access the selected newsgroup. Newsgroups may be moderated or general and there are no security restrictions on accessing newsgroups. A link is provided to access a download area where a newsreader can be obtained if necessary.

General Chat

Using the ActiveX chat control, a customer may join or create a chat forum appearing in the main results frame. The chat name, description and current number of customers is displayed for all current chats. Chats may be unmoderated for discussion among anyone who joins, or hosted for a specific reason, where a moderated discussion takes place. A list of upcoming featured or sponsored chats is available.

Hot Topics

Hot topics appear in the main frame when a product is chosen. It can contain late breaking product news and information. The functions frame at the bottom of the screen also changes to display product specific choices.

Browse FAQs

The browse FAQs fimction is only available after a customer has selected one of their products from the navigation frame on the Home page. A sub frame is created containing sub topics appropriate for the selected product. These sub-topics are stored in the database, and the relationship between these topics and the selected product are entered as a site administrator function. Selecting one of these sub topics queries the FAQ index of the search engine and returns a list of applicable documents. The customer can click on a document link to view the FAQ. These documents can be in text, HTML or any computer format.

Product Newsgroups

Available product newsgroups appear in the main result frame. Selecting a newsgroup link launches the customer's default newsreader to access the selected product newsgroups. Newsgroups may be moderated or general and there are no security restrictions on accessing newsgroups. A link is provided to access a download area where a newsreader can be obtained if necessary.

Product Chat

Using the ActiveX chat control, a customer may join or create a product chat forum appearing in the main results frame. The chat name, description and current number of customers is displayed for all current product related chats. Chats may be unmoderated for discussion among anyone who joins, or hosted for a specific reason, where a moderated discussion takes place. A list of upcoming featured or sponsored chats is available.

Product Support

If the customer cannot find an answer to their question using the above data sources the customer can access the Product Support area from the link in the functions frame. The customer can access a form to send in an incident report. The data on this form will be captured in a database.

Several features are provided to assist the support representatives. To provide feedback on the resolution of customer submitted support requests, the customer support representative will be able to:

View issue name, description and status of all incidents by status

View issue name, description and status of all incidents by support representative

Modify issue status

Update issue resolution type from a list of resolution options

Submit an e-mail response to a customer

Participate in product chat forums

View issues by product

Enter comments or text resolution for an issue online

Log date/time the status of an incident is updated

Assign/change incident priority or ownership

All other changes to incidents

View Submitted Incidents

The support representative can view all submitted incidents sorted by status. Another view shows all incidents sorted by status assigned to the support representative. The incident will contain the description, the support representative assigned to the incident, status, resolution type (bug fix, can't duplicate, etc.), and a field stating whether email was sent to the customer.

Update Incident Status and Resolution

Support representatives will be able to update the status, resolution type, or email sent fields of incidents assigned to them. Updates made from the Web site will be reflected in the incident database. Text resolutions may also be sent to the customer in e-mail and not maintained in the incident database. All incident changes will be customer viewable.

Email Response/Resolution

The support representative will be able to send an e-mail response to a customer's incident. Details of the incident and the customer's email address will default into the email form.

Chats

The support representative will be able to participate in product support chats through the Customer URL

Several pages are provided to assist the support representative's use of the customer support features:

View Incidents

Incidents for the current support representative can be viewed, or all incidents can be viewed, by current order status. The list box controls to select the correct view are in the function controls frame and the results appear in the main results frame. The incident name, brief description, status and email address of the customer who submitted the incident are displayed.

Change Incident Status

Each incident in the view incidents result list displays the current status in a list box. The support representative can select a new status from this box and save the changes. Saving will update the view list.

Update Resolution

Similar to the incident status, a resolution can be chosen from a predefined list for a specific incident. This resolution is saved to the database and the list is refreshed to reflect this new resolution.

Send Response Email

Selecting the email address of the customer who submitted the incident displayed in the view list will open the customer's current mail tool to allow the support representative to respond to the customer.

Several features are provided to assist the site administrators. To administer and maintain the support site, the site administrator will be able to:

Add, delete and modify product names and descriptions.

Add/change/delete access levels for site administrators and support representatives through NT security

Read instructions for installing and configuring the site through HTML text pages.

Select page templates

Add/change/delete query statements associated with each product/subtopic combination

Add/change/delete support representatives

Purge and archive function to remove outdated incident records from the database.

Manage privileges based on entitlement

Site page management tool

Manage a tool to add/change/delete links to announcements, FAQs, and the KNOWLEDGE BASE

Manage a tool to add/change/delete links for Chats and Newsgroups

Produce site statistics

Manage a FAQ setup tool

Several pages are provided to assist the sit administrator's use of the customer support features:

Product Maintenance

The main results frame contains a list of current site products and controls to modify or delete existing products. A link is provided to add new products. The function controls frame contains controls to access product maintenance, if necessary.

Template Maintenance

The site administrator can select a limited number of general site features from this page. This includes site colors, fonts, images, headers, footers, links and other features of the general site.

Security Access

The site administrator and support representative access security can be maintained using the built-in security features of an operating system such as Microsoft Windows NT (NT). Another option is to use the MCIS Membership System. A link to HTML pages describing how to administer access levels and groups in the is also provided.

General Purpose Communications

Built-in private communications technology, such as technology based on Netscape™'s Secure Sockets Layer technology, will keep communications between two parties private by encrypting the conversation between the server and all browsers that support SSL, including Microsoft Internet Explorer, Netscape Navigator and others.

Credit-card Payment

Credit-card authorization and payment will be allowed. For example, Microsoft merchant services will include the industry standard Secure Electronic Transactions (SET) protocol recently announced by Visa, MasterCard and their technology partners, including Microsoft

Site Setup Instructions

Site specific items that may need to be customized for different sites will be documented in online HTML pages. These pages will guide a site administrator in customizing and integrating their site.

Product Sub-options Maintenance

The browse FAQs feature requires a relationship to be built between each available product and the sub topics for this product. A web form will allow the site administrator to create new sub-topics and associate these sub-topics with the appropriate product. List boxes will contain available products and sub-topics from which the administrator can select to create and delete associations.

Product Option/Sub-options Query Maintenance

Each product and sub-topic pair created in the Product Sub-options Maintenance requires the appropriate query to be built to pass to the search engine. The administrator can enter the query and assign this query to the correct sub-topics. Queries are defined according to the current search engine (IR or Tripoli) and the content being searched.

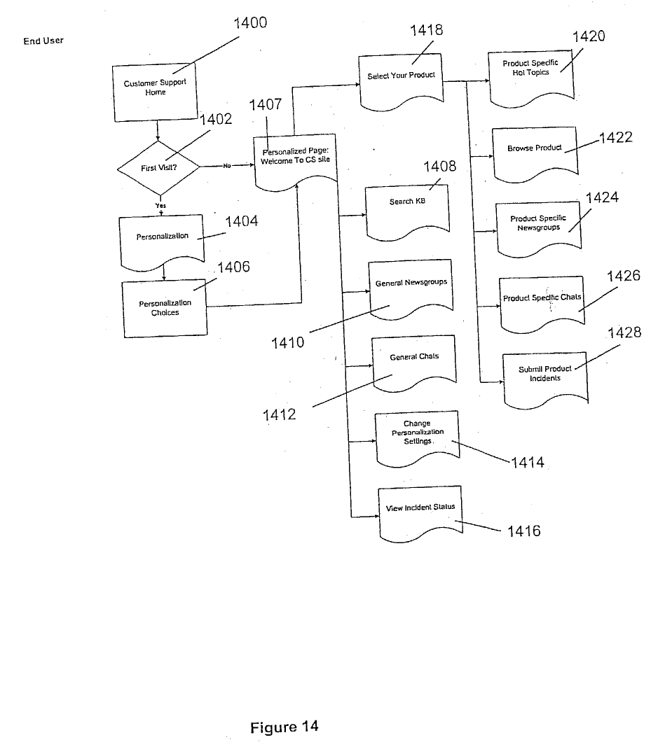

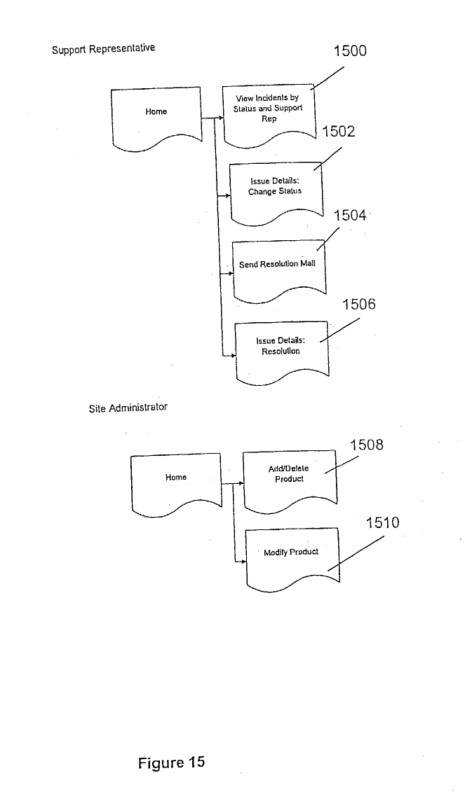

Customer service processes are illustrated in FIGS. 14 and 15. As shown in FIG. 14, upon access to the customer interface in operation 1400, it is first determined whether the present visit is a first visit in decision 1402. If it is determined that the present visit is a first visit, a personalization document 1404 is displayed after which a personal choice operation 1406 is executed to allow personalization of the customer interface.

If it is determined that the present visit is not a first visit in decision 1402, various service documents 1407 are afforded including search, newsgroup, and chatroom service documents 1408, 1410, and 1412, respectively. Also included is a change personal setting document 1414 and a view incident status document 1416. In order to further personalize the customer interface, a product may be selected via document 1418. By this feature, a product specific topic page 1420, browse topic page 1422, product specific newsgroup page 1424, product specific chat page 1426, and product incident submission page 1428 is available.

FIG. 15 illustrates support representative and site administrator operations. As shown, a support representative may view incidents via a document 1500 and further issue details (change status) via document 1502. In addition, resolution mail may be sent via page 1504 and issue details (resolution) may be issued via document 1506. Also shown in FIG. 15 are capabilities of a site administrator. As shown, products may be added and deleted via document 1508. Products may also be modified via document 1510.

Additional Services

Operations Activities—Clearinghouse applications are developed and maintained. Billing is conducted for services rendered. Network creation, operation and delivery are provided. Facilities are provided. Channel management is provided and is a process for handling different forms of delivery required for different types of partners.

Service to Publishers—Another service provided is to register and segment customers purchasing software. Transaction data may be conditioned and high-value reporting options may be provided. ESD of Licensing/OEM business may be supported. Bills to resellers/distributors can be generated. Publisher settlements processing may be supported. Market reporting capabilities may also be provided.

Service to Resellers—Customer payments may be processed in the following manner: provide a customer the ability to enter billing information; interface with a credit card clearinghouse; allow the customer to proceed with the software download (if credit card is valid). Other services include designing, building and operating reseller storefronts. A customer support center may be operated for resellers. Also provided may be integration with back-end systems.

Service to Distributors—The clearinghouse may fulfill a reseller's order in the following manner: send credit information for verification; assume reseller credit risk; prepare invoice; bill reseller; process payments; post payments to reseller accounts; prepare and distribute receipt a receipt to the customer and reseller. Second tier channel support may also be provided. Software fulfillment can be provided, as may integration with back-end systems.

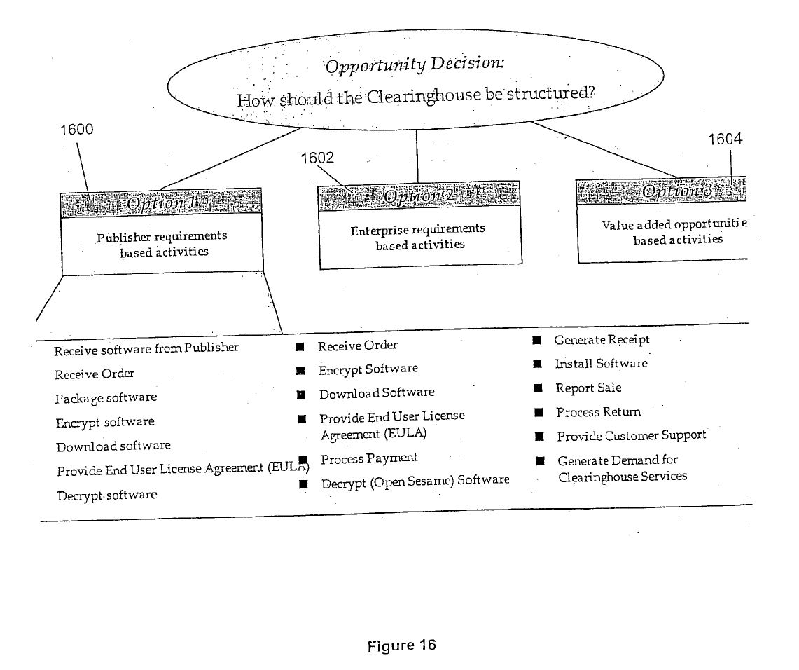

FIG. 16 is an illustration of one embodiment of the present invention in which a selected number of the foregoing features are employed to establish the clearinghouse. The selection of such features is based on how the clearinghouse is desired to be structured. Examples of frameworks include the selection of activities based on publisher requirements 1600, enterprise requirements 1602, and value-added opportunities 1604. Such features are as follows:

Receive software from Publisher

Receive Order

Package software

Encrypt software

Download software

Provide End User License Agreement (EULA)

Decrypt software

Receive Order

Encrypt Software

Download Software

Provide End User License Agreement (EULA)

Process Payment

Decrypt (Open Sesame) Software

Generate Receipt

Install Software

Report Sale

Process Return

Provide Customer Support

Generate Demand for Clearinghouse Services

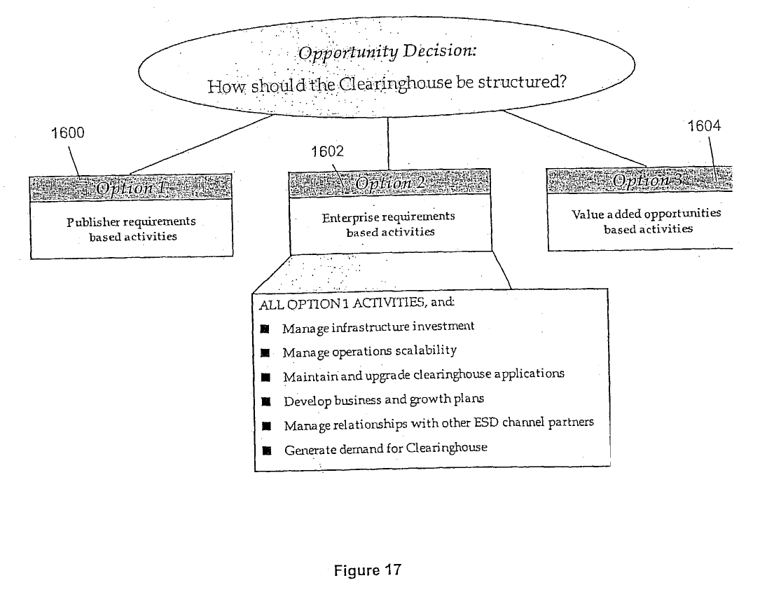

FIG. 17 illustrates a modification to the previous embodiment of FIG. 16. In the present embodiment, the features of the embodiment of FIG. 16 are included in addition to the following capabilities:

Manage infrastructure investment

Manage operations scalability

Maintain and upgrade clearinghouse applications

Develop business and growth plans

Manage relationships with other FPP ESD channel partners

Generate demand for clearinghouse services

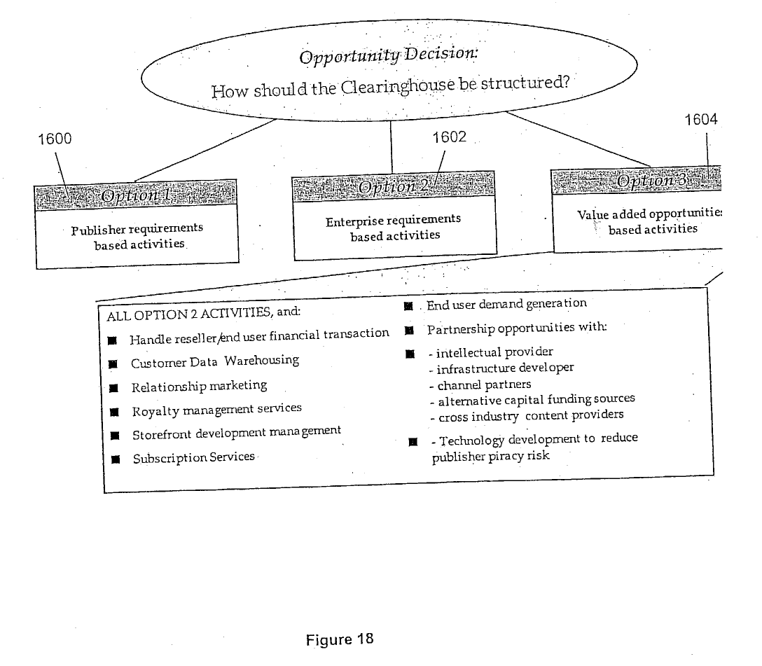

FIG. 18 illustrates a modification to the previous embodiment of FIG. 17. In the present embodiment, the features of the embodiment of FIG. 17 are included in addition to the following capabilities:

Handle reseller/end user financial transaction

Customer Data Warehousing

Relationship marketing

Royalty management services

Storefront development management

Subscription Services

End user demand generation

Partnership opportunities with:

intellectual provider

infrastructure developer

channel partners

alternative capital funding sources

cross industry content providers

Technology development to reduce publisher piracy risk

One example of use of the various foregoing features of the present invention will now be set forth. Such example involves a customer, a reseller's virtual storefront, a credit card clearinghouse, and a ESD clearinghouse. In use, a customer logs onto the reseller's storefront and thereafter chooses software to purchase. The reseller's storefront then responds by sending the customer a price quote. Next, the customer downloads the software from the ESD clearinghouse. The customer then interfaces the credit card clearinghouse by running the downloaded software and “wrapper”. Payment information is then sent to the credit card clearinghouse. The ESD clearinghouse then sends the customer a end user license agreement the terms of which must be accepted. If accepted, a proof-of-purchase is sent to the customer by the ESD clearinghouse. Then, the software is decrypted and decompressed after which standard set-up procedures are run.

User Profile

A consumer profile is created from input about the consumer. The consumer profile is preferably created in a manner that predicts a consumer's buying tendencies. The virtual shopping environment is tailored automatically based on the consumer profile. This profile may be developed from many sources including consumer input, consumer search requests, consumer buying habits, consumer income level, consumer searching habits, consumer profession, consumer education level, consumer's purpose of the pending sale, consumer's shopping habits, products purchased and returned, reasons for returning products, etc. Such information may be taken from indicia input directly by the consumer, captured as a consumer uses the network, and may be downloaded periodically from a consumer's system.

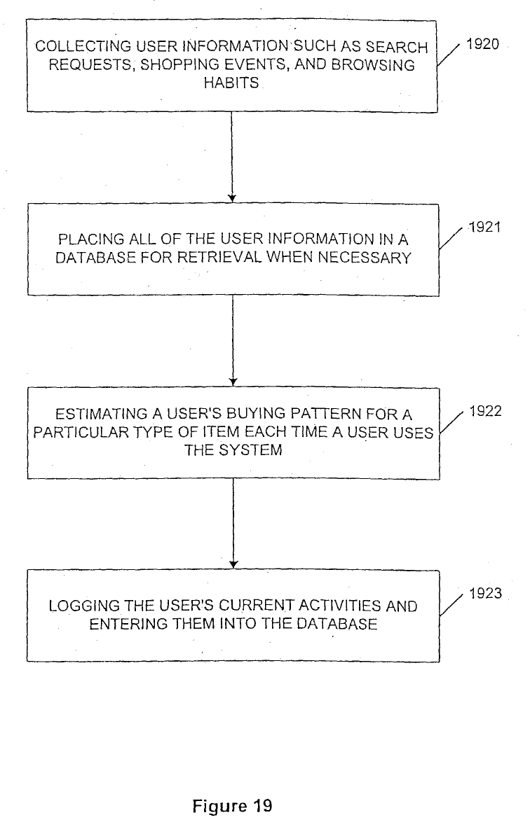

FIG. 19 illustrates one method for developing a consumer profile as set forth hereinabove, especially in reference to the customer support interface. In operation 1920, consumer information such as search requests, shopping events, and browsing habits may be collected by the system or by the consumer's computer for periodic download to the system. All of the consumer information would be placed in a database in operation 1921 for retrieval when necessary. Thus, a consumer's buying pattern for a particular type of item can be readily estimated with relative surety in operation 1922 each time a consumer uses the system. Further, the consumer's current activities can be logged and entered into the database in operation 1923, thereby ensuring up to the minute accuracy.

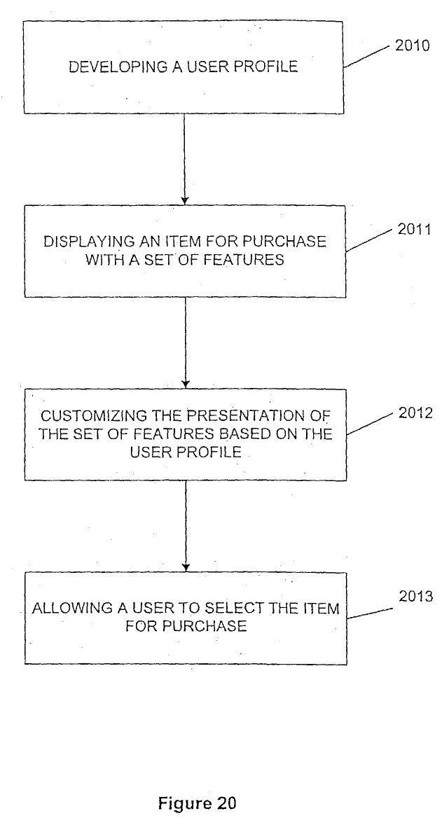

FIG. 20 illustrates yet another embodiment of the present invention in which the profile information is used in a varied manner. As shown, a consumer profile is developed in operation 2010. The consumer profile may be created based on consumer indicia input by the consumer. Such consumer indicia may include any of search requests, products purchased, products looked at but not purchased, products purchased and returned, reasons for returning products, consumer stated profile including income level, education level, stated profession, etc. as well as preferences and requirements of the consumer. In operation 2011, of FIG. 20, an item for purchase with a set of features is selected based on the consumer profile and is displayed. The item may be selected from a group of items having characteristics that corresponds to a predicted buying pattern of the consumer. The presentation of the set of features is customized based on the consumer profile in operation 2012.

The profile may also include additional information such as the billing address of the customer's credit card. This address could be utilized to identify the location of the customer for tax and shipping calculations. Other methods such as customer input and automatic identification, electronic signatures, electronic fingerprints, retinal scans and other similar identification methods could be collected in the customer profile and utilized to identify the customer and the customer's location.

It should be noted that the creation of profiles as set forth above must comply with the laws of various jurisdictions, including those of foreign countries. Treaties must also be complied with when concerning a foreign consumer. For example, automatically downloading user information from the consumer's computer may be prohibited under an applicable law.

Encryption, Decryption, & Installation of Software

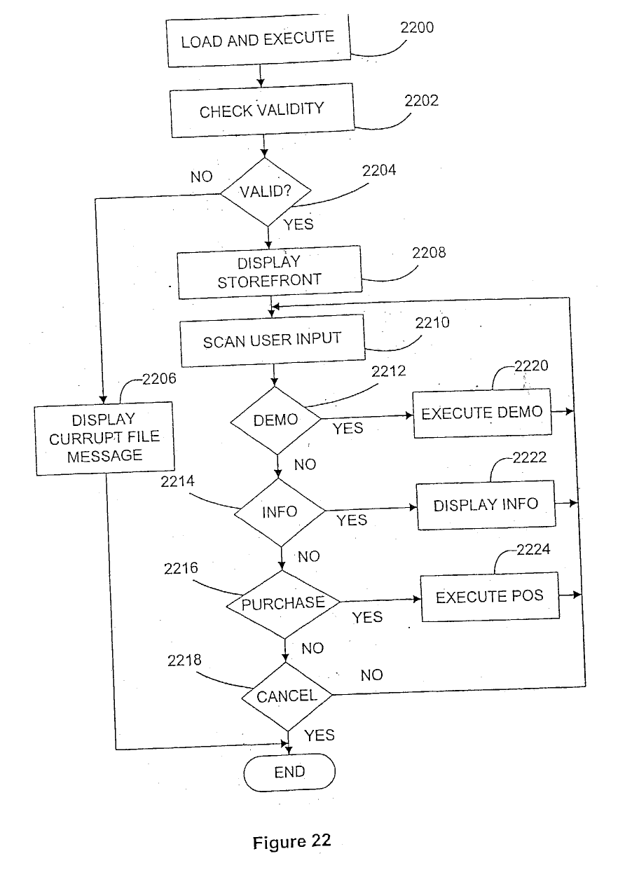

FIG. 21 illustrates the structure and manufacture of one embodiment of a packaged digital product 2110. In FIG. 21, a “storefront” program 2110a is directly executable on a personal computer. Program 2110a, detailed by flow chart in FIGS. 21 and 22, allows a user-consumer opportunity to review information and demonstration programs relative to the actual digital product available for purchase. A merchant/product data table 2110b contains information specific to the digital product available for purchase and the corresponding merchant. As described more fully hereafter, table 2110b allows program 2110a to verify the content of the digital product available for purchase. Finally, digital product 2110c contains an encrypted and compressed form of the actual digital product, i.e., a version unusable without a unlock key.

A packager 2108 application builds a packaged digital product 2110 from a variety of source material and uses compression function 2108b and encryption function 2108c to produce the final compressed and encrypted digital product 2110c. Digital product 2110c originates as a collection of files 2160 executable and/or usable on the personal computer. A merchant also provides files 2162 comprising digital logos, product information, and other forms of marketing materials for use in presentation to the user-consumer during execution of the storefront executable file 2110a. Text files 2164 provide additional information to the user-consumer during execution of the storefront executable 2110a. Finally, the storefront executable 2110a is taken by packager 2108 for incorporation into the packaged digital product 2110. During execution of packager 2108 application 2108a, an operator, merchant or vendor manually enters additional information concerning the particular digital product 2110c available for purchase, e.g., general product information, SKUs, pricing, distribution/reseller identifiers and information, merchant data, product platforms, types of credit cards accepted, and a variety of other information characterizing the particular digital product 2110c available for purchase.

Thus, packager 2108 application 2108a takes files 2160, 2162, 2164, and 2110a, and takes the operator input to produce as its output the final packaged digital product 2110. This packager 2108 output, i.e., the packaged digital product 2110, is then mass produced by copying onto a variety of distribution platforms, e.g., CD ROMs, distribution diskettes, posting on bulletin boards, and posting on Internet sites. Once the packaged digital products 2110 are publicly distributed, the user-consumers obtain copies of digital products 2110 and execute the packaged digital products 2110 on their personal computers for use thereon.

Important to note, the final packaged digital product 2110 may be distributed across a wide variety of platforms, e.g., distribution diskettes, CD ROM, bulletin board posting, and Internet availability.

FIG. 22 illustrates by flow chart execution of a packaged digital product 2110 on the personal computer. Beginning at block 2200 in FIG. 22, portion 2110a of product 2110 is loaded and execution begins. In block 2202, portion 2110b of product 2110 is read and compared to portion 2110c. The merchant/product data table 2110b must accurately describe the content of portion 2110c. For example, the number of files, file sizes, check sum values, and a variety of other aspects of portion 2110c must correspond to the description provided in table 2110b. This prevents delivery of a corrupted form of the digital product. In decision block 2204, if the validity check shows corruption or viral infection, then processing branches through block 2206, where the user consumer receives a “corrupt file” message indicating inability to unpackage the product, and processing terminates. Otherwise, a positive validity check advances processing from decision block 2204 to decision block 2208.

In block 2208, the computer presents the user-consumer with a storefront screen display. For example, the publishing merchant logo and associated information concerning the digital product available for purchase may be displayed. Further, the user is given options at this point regarding the review and purchasing steps associated with the digital product available for purchase. The storefront display includes user input opportunities, e.g., mouse-activated buttons, to drive the program. In block 2210, the computer scans for user input, e.g., scans for activation of one of the mouse-activated buttons. Decision blocks 2212, 2214, 2216, and 2218 represent user selected options regarding presentation of demonstration programs, presentation of information screens, execution of purchase or point of sale programming, and a cancel option, respectively.

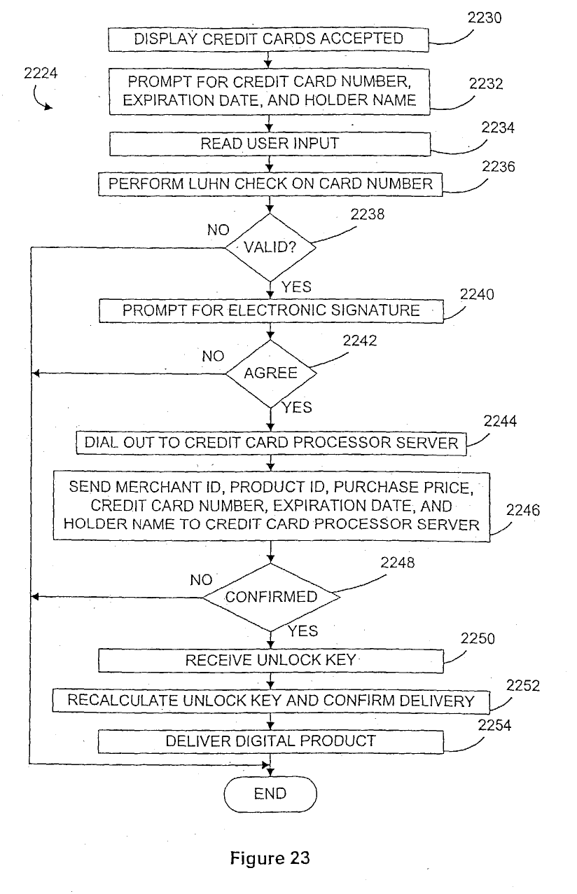

If the user selects the demonstration option, then processing branches through block 2220 where the computer executes a demonstration program relative to the digital product available for purchase and processing returns to block 2210. If the user selects an information option, then processing branches at block 2214 through block 2222 where the computer displays information screens concerning the product available for purchase and processing returns to block 2210. If the user selects the purchase option, then processing branches at block 2216 through block 2224 where the computer executes a point of sale (POS) program and processing returns to block 2210. The POS program of block 2224 is more fully detailed in FIG. 23 and discussed more fully hereafter. Finally, if the user selects the cancel option, then processing terminates following block 2218.

FIG. 23 illustrates in more detail the point of sale (POS) programming represented in block 2224 of FIG. 22. In FIG. 23, processing begins in block 2230 where the computer displays the credit cards accepted. In block 2232, the computer prompts the user-consumer for a credit card number, expiration date, and holder name. Continuing to block 2234, the computer reads the user input, i.e., reads the credit card information provided by the user-consumer.

In block 2236, the computer performs an LUHN check on the credit card number provided. A valid credit card number will conform to this preliminary test, i.e., have an appropriate MOD 10 result when applied to the LUHN check. If the credit card number fails the LUHN check, then processing terminates at decision block 2238. Otherwise, processing advances to block 2240 where the computer obtains an “electronic signature” from the user-consumer. At this point, the computer prompts for purchase confirmation including the purchase price and a final opportunity to decline purchase. If the user does not agree to the purchase, then processing terminates following decision block 2242, otherwise processing advances to block 2244.

In block 2244, the computer dials out to the credit card processor server in the direct, private, one-to-one telephone connection. Once the connection is established, the computer in block 2246 sends the merchant ID, product ID, purchase price, credit card number, expiration date, holder name, and any other required transaction data to the credit card processor server. The credit card processor server interacts directly with the credit card bank network. If the transaction is not confirmed by the credit card processor server, then processing branches at decision block 2248 and terminates. Otherwise, processing advances to block 2250 where the computer receives from the credit card processor server the unlock key needed to “unpackage” the digital product stored in portion 2110c of digital product 2110. In block 2252, the computer recalculates the unlock key to verify accuracy and also confirms to the credit card processor server delivery of the unlock key. Processing then advances to block 2254 where the computer delivers the digital product, i.e., decompresses and decrypts portion 2110c of packaged digital product 2110. A usable version of the digital product purchased is thereby copied onto the personal computer.

At this point, the user-consumer has successfully received a working version of the digital product purchased. The merchant need not be involved in the purchase step, but has knowledge of the purchase by virtue of being credited the purchase price in the credit card bank network.

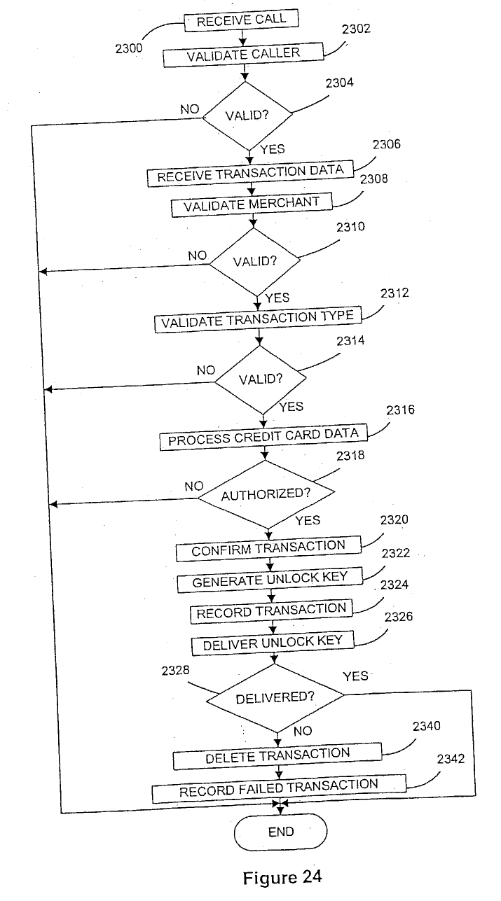

FIG. 24 illustrates programming activity at the credit card processor server. In FIG. 24, processing begins in block 2300 where the credit card processor server receives a call from a personal computer executing a packaged digital product 2110. This step corresponds to block 2244 of FIG. 23. The server then validates the call in block 2302 invalid, i.e., not originating from a packaged digital products 2110, then processing branches at decision block 2304 and terminates. Otherwise, in block 2306 the server receives transaction data. More particularly, the server receives the data sent in block 2246 of FIG. 23. The server then accesses a merchant data base (not shown) and compares the received merchant ID with a list of merchants registered for activity on system. If the merchant indicated is not a valid merchant, then processing branches at decision block 2310 and terminates. Otherwise, processing advances to block 2312 where the processor server validates the transaction type. An invalid transaction type causes termination at decision block 2314, otherwise the credit card processor server processes the credit card data in block 2316. More particularly, credit card processor server interacts with a bank network to accomplish a credit/debit transaction in the network debiting the user-consumer and crediting the identified publishing merchant. If, for some reason, the credit card transaction is not authorized, then processing branches at decision block 2318 and terminates. Otherwise, the server confirms to the personal computer the credit card transaction in block 2320. This step corresponds to block 2248 in FIG. 23.

Continuing to block 2322, the credit card processor server generates the unlock key required to make available the digital product selected for purchase. In block 2324 and 2326, a server records the credit card transaction and delivers the unlock key to a personal computer, respectively. If the computer confirms delivery of the unlock key, as indicated in block 2328 of FIG. 23, then processing terminates. Otherwise, the credit card processor server executes blocks 2340 and 2342 where the credit card transaction is deleted and a failed transaction is recorded, respectively.

Thus, the computer and credit card processor server interact automatically and directly to accomplish a credit/debit transaction without providing sensitive credit card data to any entity other than the credit card bank network. The publishing merchant need not be involved in the purchase and delivery steps. User-consumer need only enter his or her credit card information, and wait briefly, e.g., approximately one minute, while the automated transaction between the computer and server occurs. Following this brief interaction, a useable form of the digital product is made available to the user-consumer. The time required to decrypt and decompress the purchased digital product depends on the size and compression technology used, but only several minutes are typically needed to deliver the digital product to the user-consumer. Accordingly, once the user-consumer decides to purchase a digital product and initiates the purchase step, the digital product is available for use within a very short time span. Further, the user-consumer need not interact with any other person, e.g., an operator, nor manipulate complex encryption keys to make use of the purchased digital product. The user-consumer gets virtually instantaneous gratification following a decision to purchase a digital product.

Trusted Services

In one aspect of the present invention, the Authorized Clearinghouse provides trusted services to all the software publishers and channel partners which enable two key components of the ESD model, the secure electronic packaging and the End User License Agreement (EULA) management and authentication. These functions may be managed by an impartial third party who is motivated and rewarded for accurate counting and enabling of the ESD market in general. These functions are the “Federal Reserve Bank” functions of ESD similar to the ASCAP or BMI type functions from the music industry. The clearinghouses may perform trust functions that could create conflict of interest questions if they were managed by a software publisher or traditional distribution channel partner.

Financial institutions, as time-tested suppliers of trust in traditional commerce, are in a strong position to provide the trust missing on the Internet. One organization seeking to foster trust in Internet business is the Global Trust Organization (GTO), founded by CertCo in May, 1997, and formed by ABN AMRO Bank N.V., Bank of America, Bankers Trust, Barclays Bank, Chase Manhattan, Citibank, Deutsche Bank, and Hypo Vereinsbank. It should be noted that the principles employed by the GTO may be applied to the present invention and visa-versa.

The GTO is expected to be operational in late 1999 or early 2000. These financial Institutions are adopting a set of common ground rules to equalize digital signatures and certificates around the world to ensure that a certificate issued by Deutsche Bank has the same baseline meaning and function as a Chase Manhattan-issued certificate.

Digital certificates bind identities to digital signatures through cryptography. Digital signatures, generated through cryptography, are contractually binding in much of the world, and can certify that a communication originated with a particular individual, and that the transaction took place. Digitally signed communications bind trading partners to their actions without them having to exchange physical objects, such as contracts with handwritten signatures.

Like driver's licenses or credit cards, digital certificates have meaning only when backed by a trusted entity. Although technology companies can and do issue digital certificates, and act as certificate authorities and trusted third parties, financial institutions are in a better position to create trustworthy identities. They have the assets, customer knowledge, and centuries of risk management experience that it takes to effectively stand behind electronic credentials. Financial institutions also own global networks, round-the-clock operating centers, and secure messaging systems-all key pieces for a secure e-commerce infrastructure.

The GTO's eight founding financial institutions will compose the root certificate authority (CA). The GTO root CA will certify financial institutions around the world as GTO members. These certified financial institutions will, in turn, issue digital certificates around the world under the GTO name. GTO electronic identities, recognizable globally, will let customers authenticate and identify themselves to any trading partner.

The GTO is an interoperable system for global identity trust, based on common business practices, system rules, and technical interoperability specifications-guidelines that standardize GTO electronic identities. Regardless of the issuer, a GTO identity will work anywhere, on any standard computer. Businesses won't need to depend on a single technology vendor or single certificate issuer.

The organization is sponsored by a global network of financial institutions to provide an extensive network of e-commerce-ready businesses that use a common risk management framework. As more financial institutions and their corporate clients join the organization, its network of known identities will expand.

The organization provides a single, simple user identity solution to identify any participating user or compliant e-commerce application.

The GTO will provide high trust to e-commerce by extending financial institutions' traditional role of identifying customers to the electronic world. Financial institutions in the organization will stand behind issued identities, provide recourse for any parties who incur losses because of a problematic identification, and provide a dispute resolution and claims processing process. This is similar to the process that makes credit cards work globally.

As commerce and the Internet converge with entities like the GTO, and as companies increasingly go on-line to find corporate customers and suppliers, compelling legal and policy questions arise. If financial institutions shepherd e-commerce, who regulates them on the Web, and how closely? What details should be left to the free market or to parties who have arrived at a good-faith meeting of the minds? What is the role of government? What international bodies, if any, should set the rules? Also, why can't governments create and manage the electronic identities on which most business-to-business internet commerce models rely?

The right decisions will give companies a chance to flourish on the Internet. The wrong decisions will stifle opportunities. Too much regulation could eliminate the enormous efficiencies of business-to-business e-commerce. Too little regulation could make unwitting companies prey for e-commerce money machines.

For the most part, the optimal balance between regulation and free on-line commerce has been struck by default. Contract law, banking regulations, and market forces have put all the big pieces in place for a business-to-business e-commerce environment that protects users from fraud while allowing commerce to thrive. The relative stability of the current e-commerce regulatory environment argues, at the very least, for a measured, conservative, and cautious approach to adding new laws and regulations.

Policy makers can and should make refinements as the emerging market demands, but it would be folly to make them before the market takes shape. The founders of trust infrastructures, such as the GTO should establish uniform system rules, business practices, and contracts that bind all participants to those rules and practices. Such elements, combined with existing regulatory authority, provide protection for all parties through the to following mechanisms:

Consistent contracts among all members of the GTO bind users to the messages they digitally sign. Contractually binding digital signatures are essential for e-commerce to thrive, and policy makers can support this environment by recognizing digital signatures to be as legally binding as a handwritten signature.

Governments should protect the rights of GTO participants by overseeing financial institutions in e-commerce as they do current bank regulatory environments. This oversight will occur through the existing international bank regulatory infrastructure.

Governments can enable financial institutions and their customers to enter freely into contracts, such as those that govern loss recovery stemming from system use. This freedom of contract preserves a trading partner's right to select the amount of risk they wish to incur just as they do in traditional business environments.

In a public key infrastructure (PKI) with universal system rules, business practices, contracts, and government oversight, users won't need a separate dispute resolution system or an “Internet court” for protection. Participants could be protected by dispute-resolution and claims-processing mechanisms with a PKI.

Even though for-profit entities can anchor a stable e-commerce environment, some current strategies propose that governments provide identity services for businesses. Although governments do a tremendous job of authenticating identities for instance, by issuing passports-they don't have the resources of global financial institutions to stand behind those authentications and absorb:identity risk. Nor do governments have a legacy of authenticating trading partners for payment. Moreover, if governments take over authentication for their country's businesses, and each country creates a PKI, an enormous effort would be required to weave together the multitude of disparate frameworks. Extending the financial institutions' legacy of trust to the internet is a better solution.

While various embodiments have been described above, it should be understood that they have been presented by way of example only, and not limitation. Thus, the breadth and scope of a preferred embodiment should not be limited by any of the above described exemplary embodiments, but should be defined only in accordance with the following claims and their equivalents.

What is claimed is:

1. A method for identifying electronically distributed software after distribution comprising the steps of:
(a) electronically transferring software to a user over a network in exchange for payment during a transaction;
(b) downloading a proof-of-purchase after the transaction over the network, wherein the proof-of-purchase identifies the transaction;
(c) receiving a notice of return from the user over the network, wherein the notice of return includes the proof-of-purchase;
(d) verifying the authenticity of the proof-of-purchase;
(e) determining a value of a refund for a return; and
(f) processing the refund.

2. The method as set forth in claim 1, wherein the proof-of-purchase includes an identifier of a source of the software for verification.

3. The method as set forth in claim 1, and further comprising the step of storing information relating to the proof-of-purchase and the refund in a record.

4. The method as set forth in claim 3, and further comprising the step of reporting the record to a source of the software.

5. The method as set forth in claim 1, wherein the network is selected from the group of networks consisting of a LAN, a WAN, and an IP-based network.

6. The method as set forth in claim 1, wherein the network includes a hard-line.

7. A computer program embodied on a computer readable medium for identifying electronically distributed software after distribution comprising:
(a) a code segment that electronically transfers software to a user over a network in exchange for payment during a transaction;
(b) a code segment that downloads a proof-of-purchase after the transaction over the network, wherein the proof-of-purchase identifies the transaction;
(c) a code segment that receives a notice of return from the user over the network, wherein the notice of return includes the proof-of-purchase;
(d) a code segment that verifies the authenticity of the proof-of-purchase;
(e) a code segment that determines a value of a refund for a return; and
(f) a code segment that processes the refund.

8. The computer program as set forth in claim 7, wherein the proof-of-purchase includes an identifier of a source of the software for verification.

9. The computer program as set forth in claim 7, and further comprising a code segment that stores information relating to the proof-of-purchase and the refund in a record.

10. The computer program as set forth in claim 9, and further comprising a code segment that reports the record to a source of the software.

11. The computer program as set forth in claim 7, wherein the network is selected from the group of networks consisting of a LAN, a WAN, and an IP-based network.

12. The computer program as set forth in claim 7, wherein the network includes a hard-line.

13. A system for identifying electronically distributed software after distribution comprising:
(a) logic that electronically transfers software to a user over a network in exchange for payment during a transaction;
(b) logic that downloads a proof-of-purchase after the transaction over the network, wherein the proof-of-purchase identifies the transaction;
(c) logic that receives a notice of return from the user over the network, wherein the notice of return includes the proof-of-purchase;
(d) logic that verifies the authenticity of the proof-of-purchase;
(e) logic that determines a value of a refund for a return; and
(f) logic that processes the refund.

14. The system as set forth in claim 13, wherein the proof-of-purchase includes an identifier of a source of the software for verification.

15. The system as set forth in claim 13, and further comprising logic that stores information relating to the proof-of-purchase and the refund in a record.

16. The system as set forth in claim 15, and further comprising logic that reports the record to a source of the software.

17. The system as set forth in claim 13, wherein the network is selected from the group of networks consisting of a LAN, a WAN, and an IP-based network.

18. The system as set forth in claim 13, wherein the network includes a telecommunication hard-line.
